(19) United States
(12) Patent Application Publication
(10) Pub. No.: US 2026/0067835 A1
(43) Pub. Date: Mar. 5, 2026

(54) SYNCHRONIZATION SIGNAL BLOCK PATTERN SWITCHING WITH CONFIGURED OFFSETS FROM PHYSICAL BROADCAST CHANNEL

(71) Applicant: QUALCOMM Incorporated, San Diego, CA (US)

(72) Inventors: Yongle WU, San Diego, CA (US); Jing JIANG, San Diego, CA (US); Hari SANKAR, San Diego, CA (US); Yan ZHOU, San Diego, CA (US); Yong LI, San Diego, CA (US); Raghu Narayan CHALLA, San Diego, CA (US); Peter GAAL, San Diego, CA (US)

(21) Appl. No.: 18/821,869

(22) Filed: Aug. 30, 2024

(51) Int. Cl. H04W 56/00; H04L 1/00; H04W 48/16

(52) U.S. Cl. CPC H04W 56/001; H04L 1/0038; H04W 48/16

(57) ABSTRACT

Systems and techniques are provided for wireless communication. For example, a network entity can detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS). The network entity can determine a configured frequency offset from the synchronization information to a physical broadcast channel (PBCH) included in the SSB transmission, wherein the configured frequency offset is indicative of a second center frequency associated with the PBCH. The network entity can decode the PBCH based on the configured frequency offset.

### INTRODUCTION

Aspects of the present disclosure generally relate to wireless communication. In some implementations, examples are described for reducing the number of Global Synchronization Channel Number (GSCN) raster points for a user equipment (UE), based on a configurable offset between synchronization information and a physical broadcast channel (PBCH) of a synchronization signal block (SSB).

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes at least one memory and at least one processor coupled to the at least one memory. The network entity is configured to: detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); determine a configured frequency offset from the synchronization information to a physical broadcast channel (PBCH) included in the SSB transmission, wherein the configured frequency offset is indicative of a second center frequency associated with the PBCH; and decode the PBCH based on the configured frequency offset.

In another example, a method for wireless communication is provided, the method including: detecting synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); determining a configured frequency offset from the synchronization information to a physical broadcast channel (PBCH) included in the SSB transmission, wherein the configured frequency offset is indicative of a second center frequency associated with the PBCH; and decoding the PBCH based on the configured frequency offset.

In another example, a non-transitory computer-readable storage medium comprising instructions stored thereon which, when executed by at least one processor, causes the at least one processor to: detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); determine a configured frequency offset from the synchronization information to a physical broadcast channel (PBCH) included in the SSB transmission, wherein the configured frequency offset is indicative of a second center frequency associated with the PBCH; and decode the PBCH based on the configured frequency offset.

In another example, an apparatus is provided for wireless communication. The apparatus includes: means for detecting synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); means for determining a configured frequency offset from the synchronization information to a physical broadcast channel (PBCH) included in the SSB transmission, wherein the configured frequency offset is indicative of a second center frequency associated with the PBCH; and means for decoding the PBCH based on the configured frequency offset.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5A is a diagram illustrating an example of physical channels and reference signals in a wireless network, in accordance with some examples;

FIG. 5B is a diagram illustrating an example of a synchronization signal block (SSB), in accordance with some examples;

FIG. 6 is a diagram illustrating a first, second, and third synchronization signal block (SSB) pattern in the frequency domain, each respective SSB pattern including a primary synchronization signal (PSS), a secondary synchronization signal (SSS), and a physical broadcast channel (PBCH), in accordance with some examples;

FIG. 7 is a diagram illustrating a first example configuration for resource element (RE) mapping for the three respective SSB patterns of FIG. 6, in accordance with some examples;

FIG. 8 is a diagram illustrating a second example configuration for RE mapping for the three respective SSB patterns of FIG. 6, in accordance with some examples;

FIG. 9 is a diagram illustrating an example of Global Synchronization Channel Number (GSCN) raster location coverage for a plurality of downlink channels each offset by one resource block (RB), based on using the first, second, and third SSB patterns of FIG. 6, in accordance with some examples;

FIG. 10 is a flow diagram illustrating an example of a process for wireless communication, in accordance with some examples;

FIG. 11 is a flow diagram illustrating another example of a process for wireless communication, in accordance with some examples; and

FIG. 12 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, physical channels can correspond to sets of time-frequency resources used for transmission of particular transport channel data, control information, or indicator information. For instance, each transport channel can be mapped to a corresponding physical channel. The physical downlink shared channel (PDSCH) may carry and/or be used to communicate user data and paging information to a user equipment (UE) or other terminal. The physical downlink control channel (PDCCH) may carry and/or be used to communicate control information, including scheduling decisions for PDSCH reception, and/or for scheduling grants enabling transmission on the physical uplink shared channel (PUSCH), etc. The physical broadcast channel (PBCH) may carry broadcasts of network information utilized by UEs establishing a connection with the network. For example, the PBCH may carry and/or be used to communicate a Master Information Block (MIB), where the MIB includes various network configuration parameters that can be used by a UE to perform initial access to the network.

A synchronization signal block (SSB) can be transmitted by a network entity and utilized by a UE (e.g., a UE receiving the transmitted SSB) to perform initial access, cell selection or reselection, and/or handover operations. For example, an SSB can carry one or more synchronization signals that can be utilized by a UE to perform a cell search procedure to acquire time and frequency synchronization with a cell and to detect a physical layer cell ID of the cell. An SSB may carry or include information used for initial network acquisition and synchronization. For example, an SSB can carry or include one or more of a primary synchronization signal (PSS), a secondary synchronization signal (SSS), a PBCH, and/or a PBCH DMRS. In some examples, an SSB includes synchronization information and a PBCH, where the synchronization information includes at least one of a PSS and an SSS. For example, in some cases the synchronization information includes a PSS. In some cases, the synchronization information includes an SSS. In some cases, the synchronization information includes a PSS and an SSS. As used herein, the “synchronization information” included in an SSB may be used to refer to a PSS only, an SSS only, and/or both a PSS and an SSS. An SSB may also be referred to as a synchronization signal/PBCH (SS/PBCH) block. In some examples, a base station may transmit multiple SSBs on multiple corresponding beams, and the SSBs may be used for beam selection at a UE.

In 5G NR, SSB positions are flexible in the time and frequency domains, allowing the network to adapt to different deployment scenarios and/or to accommodate the flexible NR DL channels. The Global Synchronization Channel Number (GSCN) is a parameter that can be used to indicate the various respective SSB positions in the frequency domain. For example, the GSCN may be a set of pre-defined (e.g., configured) frequency points that are used to determine where the SSBs can be transmitted within the frequency spectrum. A GSCN frequency point may also be referred to as a “GSCN raster,” a “synchronization raster,” a “raster,” and/or a “raster center frequency,” etc.

Each GSCN raster can correspond to a particular frequency that is aligned with an SSB center frequency. For example, an SSB may be transmitted with a center frequency that is selected from among the plurality of GSCN rasters (e.g., frequency points) that are configured for the network. The GSCN can be used to standardize the frequencies across which UEs and/or other network devices will perform searches for network synchronization. In some examples, the GSCN may be implemented as an integer value ranging from 0 to 2999, and can represent a frequency grid with a configured GSCN spacing between consecutive GSCN rasters (e.g., the GSCN value ‘1’ is separated from the GSCN value ‘2’ by a GSCN spacing; the GSCN value ‘2’ is separated from the GSCN value ‘3’ by a GSCN spacing; etc.).

In some cases, the SSB center frequency may be determined by the GSCN and the subcarrier spacing (SCS) of the SSB. The GSCN spacing between consecutive or adjacent GSCN frequency points of the GSCN raster can be based at least in part on the SCS and the bandwidth of the synchronization information (e.g., PSS and/or SSS) included in the SSB. The GSCN spacing may be further based on the minimum downlink (DL) bandwidth and the SSB bandwidth utilized by the network.

In some examples, the GSCN spacing can be determined as GSCN spacing=(D L_{BW}−SS B_{BW})·(S S_{BW}·SCS), where D L_{BW} represents the minimum downlink bandwidth, SS B_{BW} represents the bandwidth of an SSB, S S_{BW} represents the bandwidth of the synchronization information (e.g., PSS and/or SSS) included within the SSB, and SCS represents the subcarrier spacing. Smaller values of the minimum downlink bandwidth can correspond to a smaller (e.g., closer) GSCN spacing for the SSB center frequencies in the network.

In 5G NR, to accommodate all flexible NR DL channels and SSB locations, a relatively close GSCN spacing may be utilized for the SSBs. For example, for a 30 kHz SCS, a minimum DL bandwidth of 24 resource blocks (RBs) (e.g., 10 megahertz (MHz)), an SSB bandwidth of 20 RBs, and a synchronization information (e.g., PSS and/or SSS) bandwidth of 12 RBs, the GSCN spacing can be equal to (24−20)·(12·30)=1.44 MHz.

Smaller values of the GSCN spacing (e.g., a closer or tighter GSCN spacing between the adjacent center frequencies that may be used for SSB transmission) can correspond to longer scan times by a UE that performs a full frequency scan (e.g., an exhaustive search over all GSCN points). For example, the full frequency scan may be performed by the UE to search over all GSCN points to find an available network to access (e.g., the UE may perform a full frequency scan to search for available SSBs, based on the UE searching over all GSCN points within a configured frequency range and separated by the GSCN spacing).

In some examples, a full frequency scan by the UE is based on the UE searching over all GSCN points within a configured or determined frequency range, and may be performed during an initial cell search when the UE is not synchronized with the network. For example, the UE can first determine the configured frequency range to scan (e.g., based on the supported bands of the UE and/or based on the network's configuration). For the determined frequency range, the UE can begin the full frequency scan by setting its receiver to the lowest GSCN within the frequency range and attempting to detect the synchronization information (e.g., PSS and/or SSS) of the SSB. If the UE successfully detects the PSS and/or SSS included in the synchronization information of the SSB, the UE can decode the PBCH of the SSB to obtain the network information included in the MIB. If the UE does not successfully detect the PSS and/or SSS included in the synchronization information of the SSB, the UE can move to the next GSCN (e.g., increment the GSCN value) and repeat the process above. The UE continues scanning until the UE detects and decodes an SSB, or else until the UE has completed the search over all GSCN points within the determined frequency range.

For a fixed size of the configured frequency range within which the UE performs the search for available SSBs, a closer GSCN spacing corresponds to a larger number of GSCN points that are individually checked by the UE during the full frequency scan. A larger number of GSCN points that must be checked by the UE corresponds to an increased scan time for performing the full frequency scan by the UE. There is a need for systems and techniques that can be used to increase the GSCN spacing to reduce the scan or search time associated with a UE searching for available SSBs. There is a further need for systems and techniques that can be used to increase the GSCN spacing without changing the minimum downlink bandwidth (e.g., the DL channel bandwidth), the SSB bandwidth, or the SCS (e.g., which may have respective values specified by a network standard, etc.). For example, there is a need for systems and techniques that can be used to increase the GSCN spacing by changing only an effective bandwidth of the synchronization signals (e.g., synchronization information including one or more of a PSS or an SSS) included within the SSB.

Systems, apparatuses, processes (also referred to as methods), and computer-readable media (collectively referred to as “systems and techniques”) are described herein that can be used to provide multiple SSB patterns with each respective SSB pattern utilizing a different configured offset from the PBCH to the synchronization information (e.g., PSS and/or SSS) that are included within an SSB. The systems and techniques can utilize SSB pattern switching to reduce the number of rasters (e.g., GSCN points) that are scanned (e.g., searched) by a UE during the search for available SSBs during an initial cell search and/or when a UE is not synchronized with the network.

For example, a first SSB pattern can be based on the synchronization information (e.g., PSS and/or SSS) and PBCH of the SSB using the same center frequency. Additional SSB patterns can be implemented using different offsets between the PBCH and the synchronization information (e.g., PSS and/or SSS) of the SSB. For example, a second SSB pattern can be based on the synchronization information (e.g., PSS and/or SSS) having a center frequency that is higher than the PBCH center frequency. A third SSB pattern can be based on the synchronization information (e.g., PSS and/or SSS) having a center frequency that is lower than the PBCH center frequency, etc.

In some aspects, each respective SSB pattern of the multiple SSB patterns can correspond to one center frequency that is utilized by both a PSS and an SSS included in the synchronization information of an SSB transmission, and another center frequency that is utilized by the PBCH of the SSB transmission. The different offset associated with each respective SSB pattern can be an offset between the center frequency used for the PSS and the SSS included in the synchronization information, and the center frequency used for the PBCH.

In some examples, the offset between the synchronization information (e.g., PSS and/or SSS) center frequency and the PBCH center frequency can be referred to as an “SSB pattern offset” or an “SSB offset.” In some aspects, the SSB pattern offset can be based at least in part on the location of a downlink channel bandwidth relative to the SSB. In some aspects, a configured SSB pattern offset can correspond to a selection of a particular SSB pattern from the multiple SSB patterns. In some cases, the systems and techniques can perform SSB pattern switching to change an offset between the PBCH of an SSB and the synchronization information (e.g., PSS and/or SSS) of the SSB, using explicit signaling between a network entity (e.g., base station, gNB, etc.) and a UE.

For example, an SSS (e.g., included in the synchronization information of the SSB) can be used to encode, indicate, and/or signal first information that is indicative of the configured frequency offset or configured SSB pattern used for the transmission of the SSB. In some aspects, the first information indicative of the configured frequency offset can be obtained based on the UE decoding the SSS included in the synchronization information of the SSB. For example, the UE can decode the SSS to obtain the first information indicative of the configured frequency offset.

In some cases, the first information can comprise one or more bits. For example, one or more bits can be included in the SSS of the SSB, and may be used to indicate the configured SSB pattern (e.g., selected from the multiple SSB patterns) utilized for the SSB including the SSS. The UE can decode the one or more bits indicative of the SSB pattern, based on SSB decoding beginning from the PSS and/or SSS, before proceeding to the remaining portions of the PBCH included in the same SSB as the PSS and SSS. In one illustrative example, two or more bits can be included in the SSS and used to indicate the configured SSB pattern of the SSB that includes the SSS. The two or more bits can indicate a selection of a particular SSB pattern from a plurality of configured SSB patterns (e.g., two bits can indicate SSB pattern 1, 2, 3, 4; etc.). In some cases, the two or more bits can indicate an offset (e.g., in bandwidth, resource blocks (RBs), etc.) from the center frequency of the SSS (and/or PSS included in the synchronization information of the SSB) to the PBCH included in the same SSB. In some examples, the two or more bits can indicate a magnitude of the offset and a sign of the offset. In some cases, the two or more bits indicate of the configured SSB pattern and/or the offset from the SSS and the PBCH of an SSB may additionally be embedded in the PBCH cyclic redundancy check (CRC) mask, and used by the UE to confirm that the correct SSB pattern is used by the UE.

In some examples, the systems and techniques can utilize multiple PBCH resource element (RE) mapping configurations to arrange the RBs of an SSB (e.g., an SSB using a configured SSB pattern, also referred to as an SSB hypothesis or SSB offset hypothesis) in the frequency domain. In one illustrative example, a first RE mapping configuration can correspond to each respective SSB pattern of the plurality of SSB patterns utilizing the same RE mapping. For example, each respective SSB pattern can use an RE mapping from the lowest RB to the highest RB in the frequency domain.

In another illustrative example, a second RE mapping configuration can be implemented for each respective SSB pattern to start from the lowest RE of the set of RBs included in the synchronization information (e.g., PSS and/or SSS) of the SSB, with higher REs wrapping around to the lower RBs of the SSB after all PSS and SSS RBs have been mapped to a corresponding RE. In some aspects, each respective SSB pattern of the plurality of SSB patterns may be associated with a different offset between the synchronization information (e.g., PSS and/or SSS) center frequency and the PBCH center frequency. Each respective SSB pattern can additionally be associated with a different second RE mapping configuration, where the second RE mapping configuration starts from the lowest RE of the set of RBs included in the synchronization information (e.g., PSS and/or SSS). Using the corresponding second RE mapping configuration for each respective SSB pattern, the content in the synchronization information (e.g., PSS and/or SSS) set of RBs can be the same across each of the different respective SSB patterns.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a DU, a CU, a RU (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, or the like may include disclosure of the UE, base station, network node, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

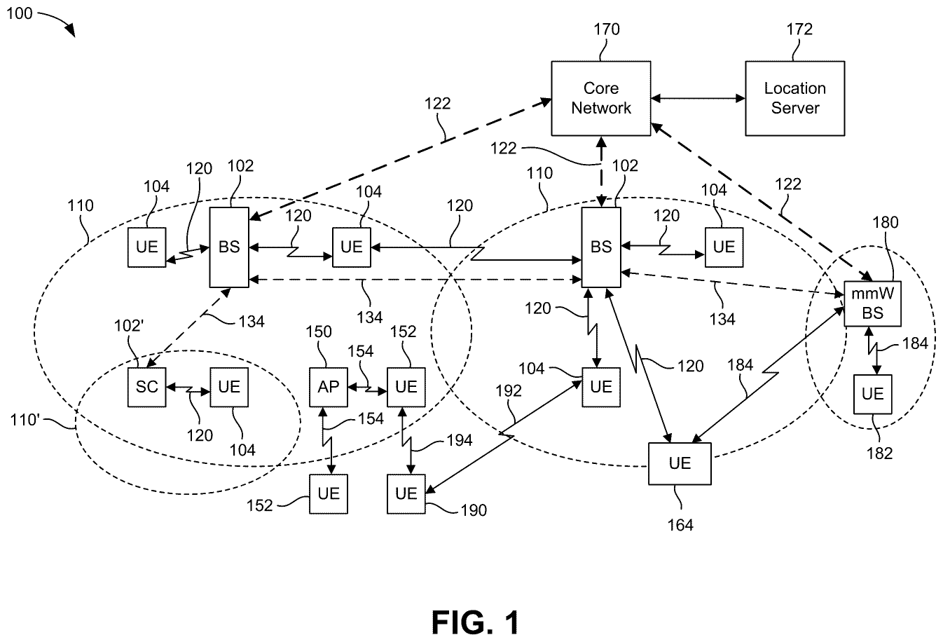

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

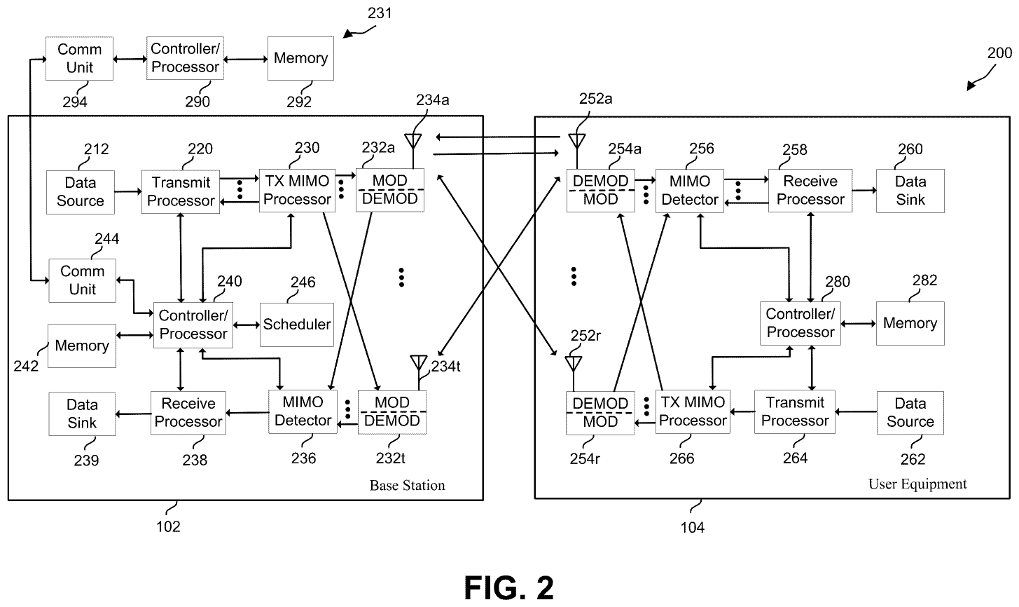

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

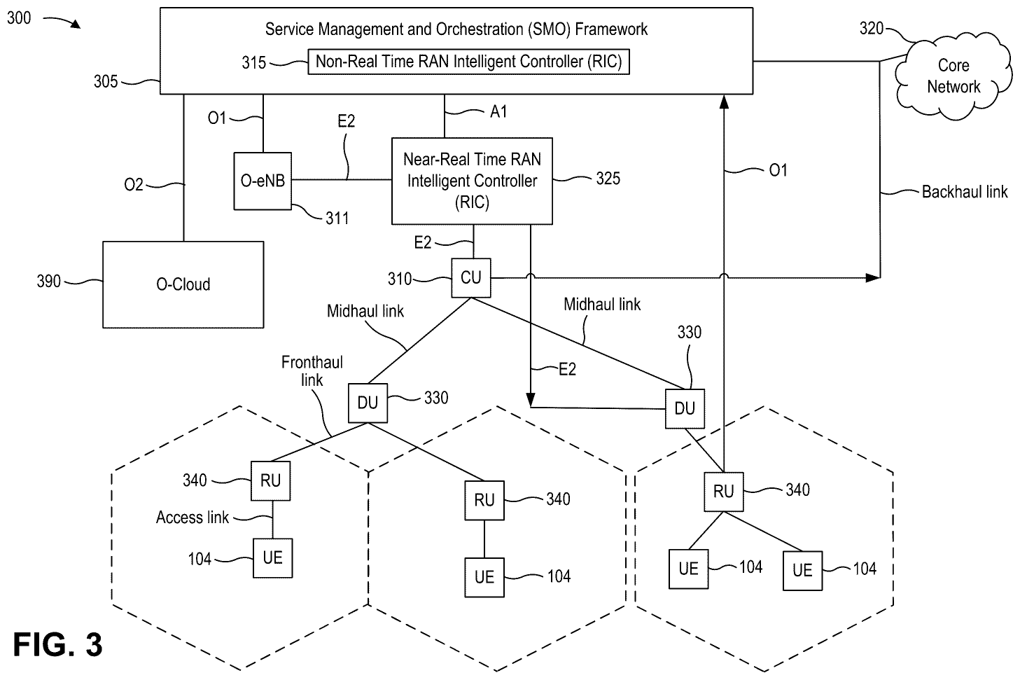

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

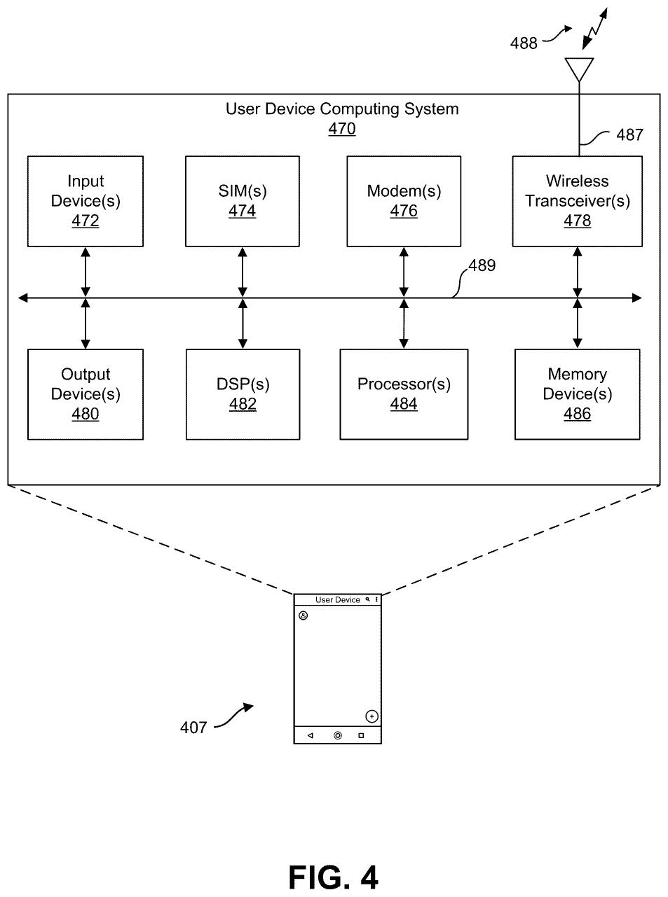

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

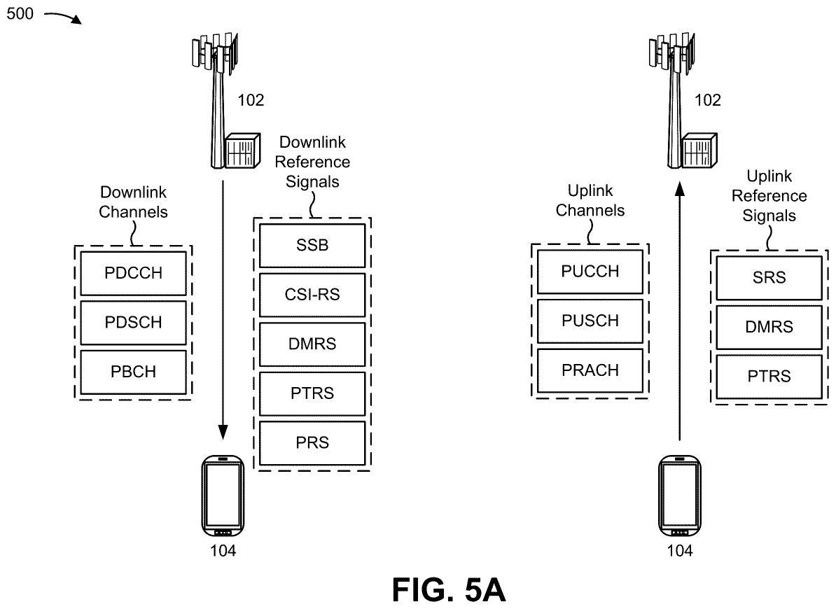

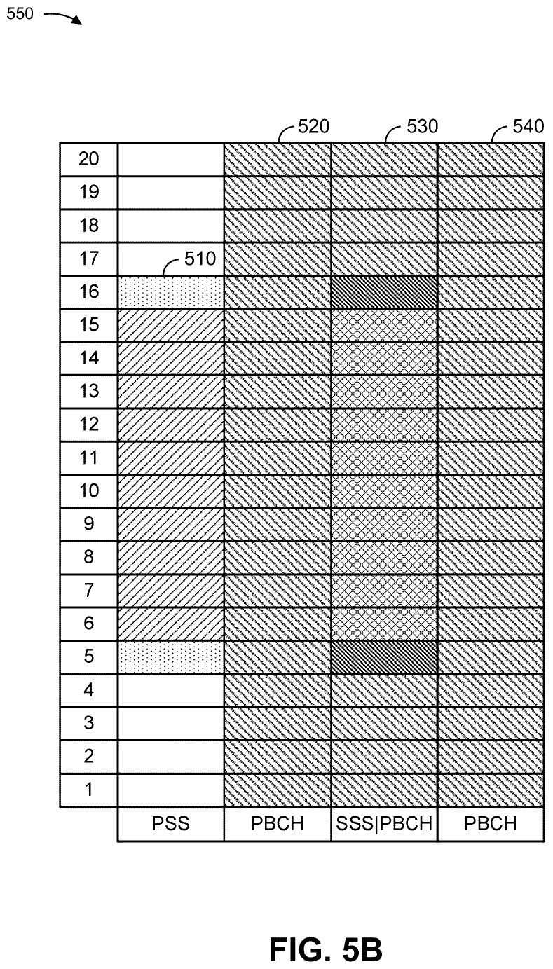

FIG. 5A is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5A, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

FIG. 5B is a diagram illustrating an example of a synchronization signal block (SSB) in 5G NR. As noted above, an SSB may carry or include information used for initial network acquisition and synchronization. For example, an SSB can carry or include a primary synchronization signal (PSS), a secondary synchronization signal (SSS), a PBCH, and/or a PBCH DMRS. In some examples, an SSB includes synchronization information and a PBCH, where the synchronization information includes at least one of a PSS and an SSS. For example, in some cases the synchronization information includes a PSS. In some cases, the synchronization information includes an SSS. In some cases, the synchronization information includes a PSS and an SSS. As used herein, the “synchronization information” included in an SSB may be used to refer to a PSS only, an SSS only, and/or both a PSS and an SSS.

As illustrated in FIG. 5B, an SSB 550 (e.g., also referred to as an SSB transmission) can comprise four symbols of 20 RBs each (e.g., a first SSB symbol 510, a second SSB symbol 520, a third SSB symbol 530, a fourth SSB symbol 540). In some examples, the SSB symbols 510-540 may each be OFDM symbols. In 5G NR, each slot may include 14 symbols. The first symbol 510 corresponds to a PSS included in the SSB (e.g., a PSS included in the synchronization information included in the SSB). The third symbol 530 corresponds to an SSS included in the SSB (e.g., an SSS included in the synchronization information included in the SSB). The second symbol 520 and the fourth symbol 540 correspond to a PBCH included in the SSB.

PBCH RBs also fill up the remaining RBs of the third symbol 530 carrying the SSS, resulting in the 20-RB symbol, as shown. The PSS and SSS (e.g., synchronization information) in the first and third symbols 510 and 530, respectively, comprise 12 RBs and the PBCHs comprise 20 RBs. The PSS and SSS (e.g., synchronization information) each comprise 127 subcarriers (e.g., each RB comprises 12 subcarriers, hence 12 RBs would be 144 subcarriers, minus some guard subcarriers, thereby reducing the total number of subcarriers to 127). Although not illustrated, the second and fourth symbols 520 and 540 carrying the PBCH include the PBCH demodulation reference signal (DMRS) and the PBCH data (e.g., PBCH payload). The 20 RBs of each PBCH may have a comb-3 DMRS.

In 5G NR, the variable subcarrier spacing (SCS) can be 3.75, 15, 30, 60, 120, 240, and 480 kHz with sub-1 GHz of 15 and 30 kHz and sub-6 GHz of 15, 30, and 60 kHz, above 6 GHz of 60 and 120 kHz, and above 24 GHz (referred to as millimeter wave, mmWave, or mmW) of 240 kHz. For SSB only cases, the SCS can be 15 kHz and 30 kHz for FR1 frequencies, and can be 120 kHz and 240 kHz for FR2 (e.g., mmW) frequencies. There may be a maximum of L SSBs in the first 5 ms of each synchronization signal (SS)-burst-set. The burst-set may have a periodicity of 5, 10, 20, 40, 80, or 160 ms, and L=4 at frequencies below 3 GHz, L=8 at frequencies between 3 and 6 GHz, and L=64 at frequencies between 6 and 52.6 GHz. The possible time-locations of the L SSBs within slots are specified in the 5G NR standard.

In 5G NR, SSB positions (e.g., the position of a single SSB transmission, such as the example SSB 550 of FIG. 5B, etc.) are flexible in the time and frequency domains, allowing the network to adapt to different deployment scenarios and/or to accommodate the flexible NR DL channels. The Global Synchronization Channel Number (GSCN) is a parameter that can be used to indicate the various respective SSB positions in the frequency domain. For example, the GSCN may be implemented as a set of pre-defined (e.g., configured) frequency points that are used to determine where the SSBs can be transmitted within the frequency spectrum. A GSCN frequency point may also be referred to as a “GSCN raster,” a “synchronization raster,” a “raster,” and/or a “raster center frequency,” etc. Each GSCN within the synchronization raster can correspond to a particular frequency that is aligned with an SSB center frequency. For example, a center frequency of the SSB 550 of FIG. 5B can be between the 10^{th} and 11^{th} RBs shown on the vertical frequency axis. The value of the center frequency that is between the 10^{th} and 11^{th} RBs of the SSB 550 can be determined and/or indicated based on a corresponding GSCN value within the synchronization raster for the network.

For example, an SSB may be transmitted with a center frequency that is selected from among the plurality of GSCN rasters (e.g., frequency points) that are configured for the network. The GSCN can be used to standardize the frequencies across which UEs and/or other network devices will perform searches for network synchronization. In some examples, the GSCN may be implemented as an integer value ranging from 0 to 2999, and can represent a frequency grid with a configured GSCN spacing between consecutive GSCN rasters (e.g., the GSCN value ‘1’ is separated from the GSCN value ‘2’ by the GSCN spacing; the GSCN value ‘2’ is separated from the GSCN value ‘3’ by the same GSCN spacing; etc.).

In some cases, the SSB center frequency may be determined by the GSCN and the subcarrier spacing (SCS) of the SSB. The GSCN spacing between consecutive or adjacent GSCN frequency points of the GSCN raster can be based at least in part on the SCS and the bandwidth of the PSS (e.g., the PSS on the first SSB symbol 510 of FIG. 5B) and SSS (e.g., the SSS on the third SSB symbol 530 of FIG. 5B) included in the SSB (e.g., the SSB 550 of FIG. 5B). The GSCN spacing may be further based on the minimum downlink (DL) bandwidth and the SSB bandwidth utilized by the network. In some examples, the GSCN spacing can be determined as GSCN spacing=(D L_{BW}−SS B_{BW})·(S S_{BW}·SCS), where D L_{BW} represents the minimum downlink bandwidth, SS B_{BW} represents the bandwidth of an SSB, S S_{BW} represents the bandwidth of the synchronization information (e.g., PSS and/or SSS) included within the SSB, and SCS represents the subcarrier spacing. Smaller values of the minimum downlink bandwidth can correspond to a smaller (e.g., closer) GSCN spacing for the SSB center frequencies in the network.

In 5G NR, to accommodate all flexible NR DL channels and SSB locations, a relatively close GSCN spacing may be utilized for the SSBs. For example, for a 30 kHz SCS, a minimum DL bandwidth of 24 resource blocks (RBs) (e.g., 10 megahertz (MHz)), an SSB bandwidth of 20 RBs, and a synchronization information (e.g., PSS and/or SSS) bandwidth of 12 RBs, the GSCN spacing can be equal to (24−20)·(12·30)=1.44 MHz. Smaller values of the GSCN spacing (e.g., a closer or tighter GSCN spacing between the adjacent center frequencies that may be used for SSB transmission) can correspond to longer scan times by a UE that performs a full frequency scan (e.g., an exhaustive search over all GSCN points). For example, the full frequency scan may be performed by the UE to search over all GSCN points to find an available network to access (e.g., the UE may perform a full frequency scan to search for available SSBs, based on the UE searching over all GSCN points within a configured frequency range and separated by the GSCN spacing).

In some examples, a full frequency scan by the UE is based on the UE searching over all GSCN points within a configured or determined frequency range, and may be performed during an initial cell search when the UE is not synchronized with the network. For example, the UE can first determine the configured frequency range to scan (e.g., based on the supported bands of the UE and/or based on the network's configuration). For the determined frequency range, the UE can begin the full frequency scan by setting its receiver to the lowest GSCN within the frequency range and attempting to detect the synchronization information (e.g., PSS and/or SSS) of the SSB. If the UE successfully detects the PSS and SSS, the UE can decode the PBCH of the SSB to obtain the network information included in the MIB. If the UE does not successfully detect the PSS and SSS, the UE can move to the next GSCN (e.g., increment the GSCN value) and repeat the process above. The UE continues scanning until the UE detects and decodes an SSB, or else until the UE has completed the search over all GSCN points within the determined frequency range.

For a fixed size of the configured frequency range within which the UE performs the search for available SSBs, a closer GSCN spacing corresponds to a larger number of GSCN points that are individually checked by the UE during the full frequency scan. A larger number of GSCN points that must be checked by the UE corresponds to an increased scan time for performing the full frequency scan by the UE. There is a need for systems and techniques that can be used to increase the GSCN spacing to reduce the scan or search time associated with a UE searching for available SSBs. There is a further need for systems and techniques that can be used to increase the GSCN spacing without changing the minimum downlink bandwidth (e.g., the DL channel bandwidth), the SSB bandwidth, or the SCS (e.g., which may have respective values specified by a network standard, etc.). For example, there is a need for systems and techniques that can be used to increase the GSCN spacing by changing only an effective bandwidth of the synchronization signals (e.g., PSS and SSS) included within the SSB.

As noted above, systems and techniques are described herein that can be used to provide multiple SSB patterns with a flexible frequency offset between the PBCH and the synchronization signals (e.g., PSS and SSS) included in an SSB transmission. For example, each respective SSB pattern can correspond to a different frequency offset value between the PBCH of the SSB (e.g., the center frequency of the PBCH included in an SSB transmission) and the synchronization information (e.g., PSS and/or SSS) of the SSB (e.g., the center frequency of the PSS and/or SSS included in the synchronization information of the SSB transmission).

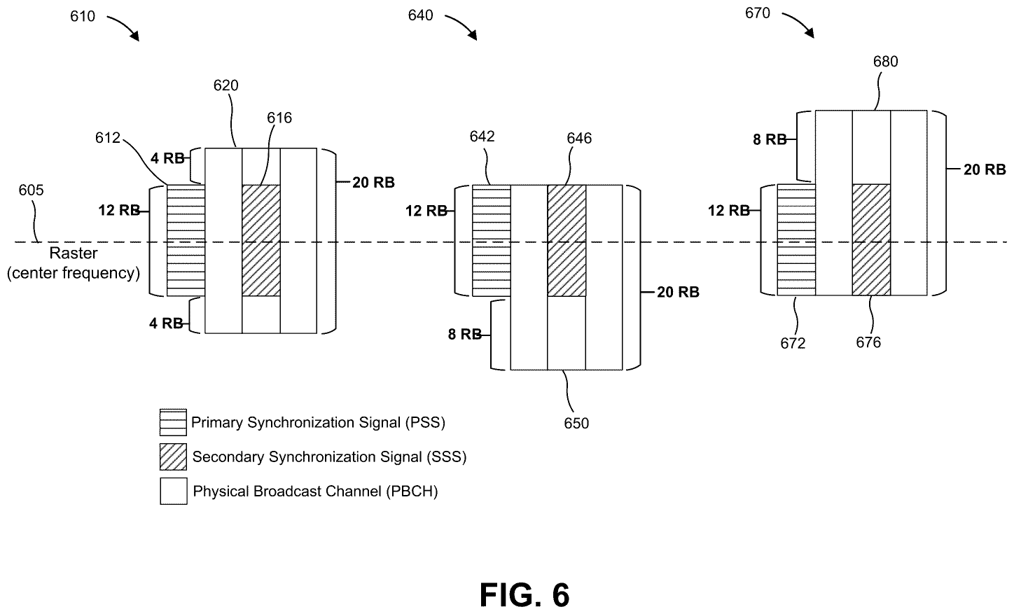

FIG. 6 is a diagram illustrating various examples of SSB patterns that can be used for respective SSB transmissions having different frequency offsets from the synchronization information (e.g., PSS and/or SSS) included in the SSB, to the PBCH included in the SSB. For example, a first SSB pattern 610 corresponds to a frequency offset value of zero from the PSS 612 and SSS 616 to the PBCH 620. A second SSB pattern 640 corresponds to a frequency offset where the PBCH 650 is shifted down (e.g., lower in frequency) relative to or from the PSS 642 and the SSS 646. A third SSB pattern 670 corresponds to a frequency offset where the PBCH 680 is shifted up (e.g., higher in frequency) relative to or from the PSS 672 and the SSS 676.

Each SSB pattern 610, 640, 670 can be associated with the same raster 605. The raster 605 can correspond to the center frequency configured for the SSB block or transmission that uses the respective SSB pattern 610, 640, 670. For example, the raster 605 can be a frequency point indicated by a Global Synchronization Channel Number (GSCN) value that is associated with the SSB transmission.

Each of the SSB patterns 610, 630, 670 uses the same raster center frequency 605, and a different respective frequency offset value. The raster center frequency 605 can be the center frequency of the respective SSS and PSS included in each of the SSB patterns 610, 640, 670. For example, each of the SSB patterns 610, 630, 670 includes a respective PSS (e.g., 612, 642, 672, respectively) that has a bandwidth centered about the raster 605 and includes a respective SSS (e.g., 616, 646, 676, respectively) that also has a bandwidth centered about the raster 605.

The PSS 612, 642, 672 can be the same for each SSB pattern 610, 640, 670 (respectively). The SSS 616, 646, 676 can also be the same for each SSB pattern 610, 640, 670. The PSS and SSS within each SSB pattern may have the same bandwidth, centered about the raster center frequency 605. For example, each PSS 612, 642, 672 can be transmitted on 12 resource blocks (RBs) in the frequency domain and centered on the raster frequency 605, and each SSS 616, 646, 676 can be transmitted (in a different/later symbol of the same SSB transmission) on the same 12 RBs in the frequency domain and centered on the raster frequency 605.

Each SSB pattern 610, 640, 670 can use the same SSB bandwidth, for example a bandwidth of 20 RBs in the frequency domain. The SSB bandwidth can be configured by the network, and each SSB transmission can use the same SSB bandwidth. In some aspects, the first SSB pattern 610 is associated with a frequency offset value of zero (e.g., no frequency offset), and the PBCH 620 includes 20 RBs (e.g., the bandwidth of the SSB) centered around the same center frequency as the PSS 612 and SSS 616. For example, the raster 605 can be the center frequency for the PSS 612, SSS 616, and PBCH 620 included in the first SSB pattern 610 with the 0 offset.

In some aspects, the first SSB pattern 610 can be the same as or similar to the SSB pattern of the example SSB 550 of FIG. 5B. For example, the PSS 612 of the first SSB pattern 610 of FIG. 6 can be the same as the PSS included in the first SSB symbol 510 of FIG. 5B. The SSS 616 of the first SSB pattern 610 of FIG. 6 can be the same as the SSS included in the third SSB symbol 530 of FIG. 5B. The PBCH 620 of the first SSB pattern 610 of FIG. 6 can be the same as the PBCH included in the second SSB symbol 520, third SSB symbol 530, and fourth SSB symbol 540 of FIG. 5B.

The first SSB pattern 610 can be implemented based on the synchronization information (e.g., PSS and/or SSS) and PBCH of the SSB using the same center frequency (e.g., the raster 605). The first SSB pattern 610 can be included in a plurality of SSB patterns corresponding to a plurality of configured frequency offsets between the PBCH and the synchronization signals (e.g., PSS and SSS) of an SSB transmission from a network entity (e.g., base station, gNB, etc.) to a network device (e.g., UE, etc.).

The plurality of SSB patterns can include one or more additional SSB patterns that are implemented using different offsets between the PBCH and the synchronization information (e.g., PSS and/or SSS) of the SSB transmission. For example, one or more additional SSB patterns can correspond to different positive valued frequency offsets where the PBCH of the SSB is shifted by one or more RBs to a second center frequency that is higher (e.g., larger) than a first center frequency corresponding to the raster 605 and the center frequency of the synchronization information (e.g., PSS and/or SSS) of the SSB.

In some aspects, the third SSB pattern 670 is an example of an additional SSB pattern corresponding to a positive valued frequency offset between the PBCH 680 and the synchronization information comprising PSS 672 and/or SSS 676. For example, the PBCH 680 of the third SSB pattern 670 is shifted upwards in the frequency domain by +4 RBs (e.g., a frequency offset of +4 RBs) relative to the zero frequency offset of the first SSB pattern 610.

In some aspects, the second SSB pattern 640 is an example of an additional SSB pattern corresponding to a negative valued frequency offset between the PBCH 650 and the synchronization information comprising PSS 642 and/or SSS 646. For example, the PBCH 650 of the second SSB pattern 640 is shifted downwards in the frequency domain by −4 RBs (e.g., a frequency offset of −4 RBs) relative to the zero frequency offset of the first SSB pattern 610.

In one illustrative example, the systems and techniques can utilize SSB pattern switching between a configured plurality of SSB patterns with different respective configured frequency offsets (e.g., the first SSB pattern 610, second SSB pattern 640, third SSB pattern 670, etc.). The SSB pattern switching can be used to reduce the number of different rasters or GSCN frequency points (e.g., such as raster 605) that are scanned (e.g., searched) by a UE during the search for SSBs during a cell search procedure performed by a UE in a standalone mode or acquisition mode where the UE is not synchronized with or connected to the network.

For example, existing approaches to SSB search and acquisition may utilize a one-to-one mapping between each raster (e.g., GSCN point) and a possible SSB position, where the possible SSB position corresponds to an SSB using the first SSB pattern 610 (e.g., zero frequency offset between the PBCH and synchronization information (e.g., PSS and/or SSS)) with a center frequency given by the particular raster/GSCN value.

In one illustrative example, the systems and techniques can utilize SSB pattern switching to reduce the effective SSB bandwidth and increase the GSCN spacing associated with SSB search and acquisition performed by a UE. For example, SSB pattern switching between the plurality of configured SSB patterns with respective frequency offsets (e.g., SSB patterns 610, 640, 670 of FIG. 6) can correspond to multiple possible SSB positions for a single raster center frequency. Using the SSB pattern switching between the plurality of configured SSB patterns, a UE can perform the SSB search and acquisition with a smaller number of RF tunes needed to search the same number of possible SSB positions. For example, using the three SSB patterns 610, 640, 670 of FIG. 6 can reduce the number of raster frequencies 605 that the UE must tune to by a factor of three, based on each of the three SSB patterns 610, 640, 670 being accessed by the UE from the same raster center frequency 605.

In some aspects, using the three SSB patterns 610, 640, 670 of FIG. 6 can reduce the total number of rasters 605 associated with a full frequency scan exhaustive search over all GSCN points during SSB search and acquisition by a UE to 1/3 of the total number of rasters needed when using only the zero frequency offset first SSB pattern 610 (e.g., which is the same as the SSB 550 of FIG. 5B).

In some examples, each respective SSB pattern of the multiple SSB patterns can correspond to a first center frequency that is utilized by the synchronization information comprising a PSS and/or an SSS (e.g., the first center frequency can be equal to the raster 605), and a second center frequency that is utilized by the PBCH (e.g., for the first SSB pattern 610, the second center frequency is also equal to the raster 605; for the second SSB pattern 640, the raster 605 shifted by the configured frequency offset of-4 RB to obtain the second center frequency; for the third SSB pattern 670, the raster 605 is shifted by the configured frequency offset of +4 RB to obtain the second center frequency). The different offset associated with each respective SSB pattern can be an offset between the center frequency used for the PSS and the SSS, and the center frequency used for the PBCH. In some examples, the offset between the synchronization information (e.g., PSS and/or SSS) center frequency and the PBCH center frequency can be referred to as an “SSB pattern offset,” an “SSB offset,” and/or a “configured frequency offset.” In some aspects, the SSB pattern offset can be based at least in part on the location of a downlink channel bandwidth relative to the SSB. In some aspects, a configured SSB pattern offset can correspond to a selection of a particular SSB pattern from the multiple SSB patterns.

In one illustrative example, the systems and techniques can perform SSB pattern switching to change an offset between the PBCH of an SSB and the synchronization information (e.g., PSS and/or SSS) of the SSB, using explicit signaling between a network entity (e.g., base station, gNB, etc.) and a network device (e.g., UE, etc.). For example, one or more bits (e.g., also referred to as “first information”) can be included in the SSS of the SSB, and may be used to indicate the configured SSB pattern (e.g., selected from the multiple SSB patterns) utilized for the SSB including the SSS. In some aspects, each SSB pattern 610, 640, 670 can include the one or more explicit signaling bits within the respective SSS 616, 646, 676 to indicate the particular SSB pattern that is used (e.g., selected from the plurality of configured SSB patterns 610, 640, 670).

The UE can decode the one or more bits indicative of the SSB pattern, based on SSB decoding beginning from the PSS and/or SSS (e.g., synchronization information of the SSB), before proceeding to the remaining portions of the PBCH included in the same SSB as the synchronization information. Based on each of the different SSB patterns 610, 640, 670 utilizing the same synchronization information (e.g., PSS and/or SSS) centered about the raster center frequency 605, the UE can detect and decode the PSS and SSS successfully for an SSB transmission utilizing any of the configured SSB patterns 610, 640, 670, and without a requirement to first determine the particular SSB pattern that is used for the SSB transmission (e.g., the UE can always detect and decode the PSS and SSS within any of the possible SSB patterns, based on the synchronization information (e.g., PSS and/or SSS) always being centered about the raster frequency 605; after successfully decoding an SSS that includes the one or more explicit signaling bits, the UE can determined the particular SSB pattern and corresponding frequency offset that was used, and can then decode the PBCH based on the determination of the particular SSB pattern and offset to apply during PBCH decoding).

In one illustrative example, two or more bits can be included in the SSS and used to indicate the configured SSB pattern of the SSB that includes the SSS. The two or more bits can indicate a selection of a particular SSB pattern from a plurality of configured SSB patterns (e.g., two bits can indicate SSB pattern 1, 2, 3, 4; etc.). In some cases, the two or more bits can indicate an offset (e.g., in bandwidth, resource blocks (RBs), etc.) from the center frequency of the synchronization information (e.g., PSS and/or SSS) (e.g., the raster 605) to the PBCH included in the same SSB as the SSS. In some examples, the two or more bits can indicate a magnitude of the offset and a sign of the offset. In some cases, the two or more bits indicate of the configured SSB pattern and/or the offset from the SSS and the PBCH of an SSB may additionally be embedded in the PBCH cyclic redundancy check (CRC) mask, and can be used by the UE to confirm that the correct SSB pattern was used by the UE during decoding of the PBCH.

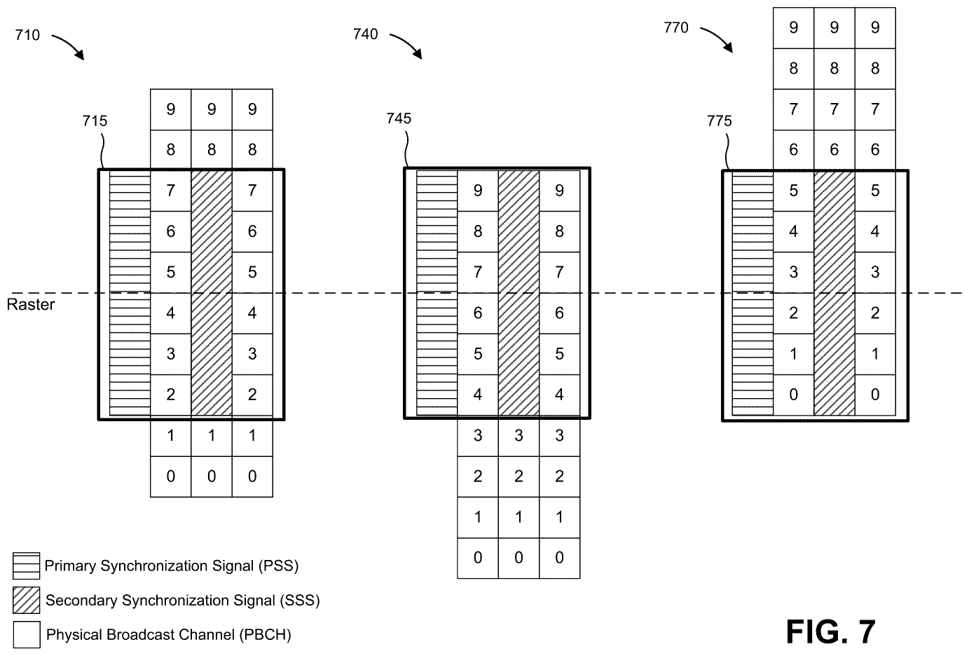

FIG. 7 is a diagram illustrating a first example configuration for PBCH resource element (RE) mapping for each of the three respective SSB patterns of FIG. 6, in accordance with some examples. The first configuration of the PBCH RE mapping can be implemented based on mapping the first bit (e.g., of a plurality of bits included in the PBCH payload or PBCH data) of the PBCH to the lowest RE and/or RB included in each respective SSB pattern 610, 640, 670, and mapping the remaining bits of the PBCH in ascending order to the remaining REs and RBs within the SSB pattern.

For example, the PBCH RE mapping configuration 710 can correspond to the first SSB pattern 610 of FIG. 6, which has a frequency offset of zero (e.g., no frequency offset) between the PBCH and synchronization information (e.g., PSS and/or SSS). The portion 715 of the PBCH RE mapping configuration 710 represents the RBs that are within the 12 RB bandwidth of the PSS and SSS of the SSB using the first SSB pattern 610. The first PBCH bit ‘0’ is mapped to the lowest RB within the SSB pattern, the second PBCH bit ‘1’ is mapped to the second lowest RB, . . . , and the last PBCH bit ‘9’ is mapped to the highest RB within the SSB pattern.

The PBCH RE mapping configuration 740 can correspond to the second SSB pattern 640 of FIG. 6, which has a frequency offset configured to shift the PBCH down in frequency relative to the raster center frequency of the synchronization information (e.g., PSS and/or SSS). The portion 745 of the PBCH RE mapping configuration 740 represents the RBs that are within the 12 RB bandwidth of the PSS and SSS of the SSB using the second SSB pattern 640. The first PBCH bit ‘0’ is again mapped to the lowest RB within the SSB 740, which is different from the lowest RB within the SSB 710.

For example, in the PBCH RE mapping configuration 710, the portion 715 of the PBCH that is aligned with the bandwidth of the PSS and SSS comprises the PBCH bits ‘2’-‘7’, while in the PBCH RE mapping configuration 740, the portion 745 of the PBCH that is aligned with the bandwidth of the PSS and SSS comprises the PBCH bits ‘4’-‘9’. In examples where the PBCH REs are mapped beginning from the lowest RE of the SSB pattern, each SSB pattern is associated with a different alignment of PBCH bits to the PSS and SSS bandwidth (e.g., as the PSS and SSS bandwidth is centered about the same raster frequency for each SSB pattern, the PSS and SSS are on the same set of RBs relative to the raster frequency for each of the SSB patterns).

The PBCH RE mapping configuration 775 can correspond to the third SSB pattern 670 of FIG. 6, which has a frequency offset configured to shift the PBCH up in frequency relative to the raster center frequency of the synchronization information (e.g., PSS and/or SSS). The portion 775 of the PBCH RE mapping configuration 770 represents the RBs that are within the 12 RB bandwidth of the PSS and SS of the SSB using the third SSB pattern 670. The first PBCH bit ‘0’ is again mapped to the lowest RB within the SSB 770, which is different from the lowest RB within the SSB 710 and is also different from the lowest RB within the SSB 740. For example, in the PBCH RE mapping configuration 770, the portion 775 of the PBCH that is aligned with the bandwidth of the PSS and SSS comprises the PBCH bits ‘0’-‘5’.

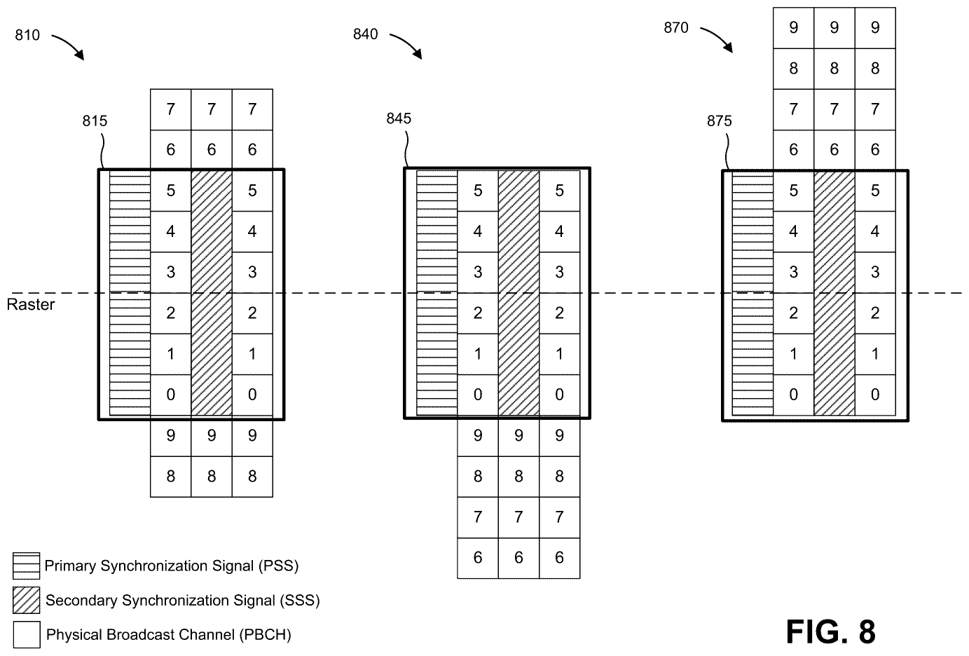

FIG. 8 is a diagram illustrating a second example configuration for PBCH RE mapping for each of the three respective SSB patterns of FIG. 6, in accordance with some examples. The second configuration of the PBCH RE mapping can be implemented based on mapping the first bit (e.g., of a plurality of bits included in the PBCH payload or PBCH data) of the PBCH to the lowest RE and/or RB that is included within the bandwidth of the PSS and SSS of each respective SSB pattern 610, 640, 670 of FIG. 6. As noted previously, the PSS and SSS are provided on the same RBs within each different SSB pattern (e.g., based on the PSS and SSS each having the same configured bandwidth and each being centered about the raster center frequency). The second PBCH RE mapping configuration for the different SSB patterns can correspond to the same PBCH bits being transmitted on the RBs that are within the synchronization information (e.g., PSS and/or SSS) bandwidth centered about the raster center frequency.

For example, the PBCH RE mapping configuration 810 can correspond to the first SSB pattern 610 of FIG. 6, which has a frequency offset of zero (e.g., no frequency offset) between the PBCH and synchronization information (e.g., PSS and/or SSS). In the PBCH RE mapping configuration 810, the first PBCH bit ‘0’ is mapped to the lowest RE of the plurality of RBs within the synchronization information (e.g., PSS and/or SSS) bandwidth 815, the PBCH bit ‘7’ being mapped to the highest RE of the plurality of RBs of the SSB 810, and the remaining PBCH bits ‘8’ and ‘9’ wrapping around to map to the lowest RB and second lowest RB of the SSB 810. Based on starting the PBCH mapping at the lowest RE and RB within the synchronization information (e.g., PSS and/or SSS) bandwidth 815, the PBCH RE mapping configuration 810 includes the PBCH bits ‘0’-‘5’ within the synchronization information (e.g., PSS and/or SSS) bandwidth 815.

The PBCH RE mapping configuration 840 can correspond to the second SSB pattern 640 of FIG. 6, which has a frequency offset configured to shift the PBCH down in frequency relative to the raster center frequency of the synchronization information (e.g., PSS and/or SSS). In the PBCH RE mapping configuration 840, the first PBCH bit ‘0’ is mapped to the lowest RE of the plurality of RBs within the synchronization information (e.g., PSS and/or SSS) bandwidth 845, the PBCH bit ‘5’ is mapped to the highest RE of the plurality of RBs of the SSB 840, and the remaining PBCH bits ‘6’-‘9’ wrapping around to map to the lowest four RBs of the SSB 810. Based on starting the PBCH mapping at the lowest RE and RB within the synchronization information (e.g., PSS and/or SSS) bandwidth 845, the PBCH RE mapping configuration 840 includes the same PBCH bits ‘0’-‘5’ within the synchronization information (e.g., PSS and/or SSS) bandwidth 845 as are included within the synchronization information (e.g., PSS and/or SSS) bandwidth 815.

The PBCH RE mapping configuration 870 can correspond to the third SSB pattern 670 of FIG. 6, which has a frequency offset configured to shift the PBCH up in frequency relative to the raster center frequency of the synchronization information (e.g., PSS and/or SSS). IN the PBCH RE mapping configuration 870, the first PBCH bit ‘0’ is mapped to the lowest RE of the plurality of RBs within the synchronization information (e.g., PSS and/or SSS) bandwidth 875, the PBCH bit ‘5’ is mapped to the highest RE of the plurality of RBs within the synchronization information (e.g., PSS and/or SSS) bandwidth 875, and the remaining PBCH bits ‘6’-‘9’ are mapped to the higher RBs that are included in the SSB 870 and are outside of (e.g., higher than) the RBs of the synchronization information (e.g., PSS and/or SSS) bandwidth 875. Based on starting the PBCH mapping at the lowest RE and RB within the synchronization information (e.g., PSS and/or SSS) bandwidth 875, the PBCH RE mapping configuration 870 includes the same PBCH bits ‘0’-‘5’ within the synchronization information (e.g., PSS and/or SSS) bandwidth 875 as are included within the synchronization information (e.g., PSS and/or SSS) bandwidth 815, and as are included within the synchronization information (e.g., PSS and/or SSS) bandwidth 845.

In some examples, a UE can perform an SSB search to detect the PSS and SSS included in an SSB transmission, where the PSS and the SSS are associated with a first center frequency corresponding to a configured frequency position of the SSB transmission (e.g., the raster 605 of FIG. 6, the raster of FIG. 7, the raster of FIG. 8, etc., and/or a GSCN point or value, etc.). The UE can determine the SSB pattern and/or configured frequency offset that was used to transmit the SSB transmission. For example, the UE can determine which SSB pattern and/or frequency offset value was used for the SSB transmission, out of the plurality of SSB patterns 610, 640, 670, etc., and/or corresponding frequency offset values (e.g., 0, −4 RB, +4 RB, etc.) of FIG. 6. The UE can decode the PBCH included in the SSB transmission based on the configured frequency offset that was determined. The configured frequency offset can be indicative of a second center frequency associated with the PBCH, where the second center frequency is different from the first center frequency by an amount equal to or given by the configured frequency offset value that was determined by the UE.

In some cases, to determine the configured frequency offset, the UE can be configured to use each respective frequency offset of a configured plurality of frequency offsets to perform a blind decode of the symbols of the SSB transmission associated with the PBCH. For example, the symbols of the SSB transmission associated with the PBCH can be the second, third, and fourth SSB symbols (e.g., such as the second symbol 520, third symbol 530, and fourth symbol 540 of the SSB 550 of FIG. 5B).

In some cases, the blind decode can be performed when the UE does not receive signaling indicative of the particular SSB pattern and corresponding configured frequency offset that was used for the SSB transmission (e.g., the SSS of the SSB does not include the one or more bits indicative of the SSB pattern and/or offset). In some cases, a connected mode or idle mode UE does not perform SSB search or acquisition, based on the connected mode or idle mode UE already having established synchronization with the network. For example, the connected or idle mode UE can receive separate signaling from the network that is indicative of the particular SSB pattern and configured frequency offset being used for SSB transmissions (e.g., the connected or idle mode UE can receive RRC or other signaling based on already being synchronized and connected with the network, and may skip the explicit signaling of the SSB pattern or configured offset via the one or more bits within the SSS and may skip the implicit signaling or determination of the SSB pattern and/or configured offset via the blind decoding using each SSB pattern as the hypothesis). In some aspects, the various SSB patterns and frequency offsets can be implemented without impacting the use by the UE of the PBCH for tracking loops and beam management.

In some examples, during acquisition, a UE may be configured to perform blind decoding using each respective SSB pattern and/or configured frequency offset between the PBCH and synchronization information (e.g., PSS and/or SSS) as the decoding hypothesis. As used herein, the decoding hypothesis and/or configured frequency offset used for the decoding hypothesis may also be referred to as a “candidate frequency offset.” For example, the UE can be configured to perform blind decoding of a received SSB transmission based on using one or more candidate frequency offsets to attempt to decode the received SSB transmission. In some example, the one or more candidate frequency offsets are selected and/or determined from a plurality of frequency offsets configured for SSB transmissions. For example, the one or more candidate frequency offsets can be selected from among the configured SSB patterns, where each configured SSB pattern is associated with a different frequency offset. The UE can attempt decoding using different candidate frequency offsets until a successful decoding result is obtained or determined (e.g., blind decode of symbols of the SSB transmission).

For example, the UE can use the candidate frequency offset to decode the PBCH and determine corresponding decoded information (e.g., a decoding result for the blind decode attempt using the candidate frequency offset). The UE can determine whether the decoded information includes decoded symbols of the PBCH. For example, if the decoded information does not include decoded symbols of the PBCH, or does not include a decoded symbol for all symbols of the PBCH, the UE may determine that the candidate frequency offset used to generate the decoded information is not the correct candidate (e.g., incorrect decoding hypothesis). The UE can select a different candidate frequency offset, and repeat the process of attempting to decode the PBCH using the candidate frequency offset, and determining if the corresponding decoded information includes the decoded symbols of the PBCH.

Based on the decoded information including decoded symbols of the PBCH, the UE can determine that the blind decoding attempt using the particular candidate frequency offset is a successful blind decode result. The UE can determine, based on the decoded information including decoded symbols of the PBCH, that the configured frequency offset for the received SSB transmission is the particular candidate frequency offset associated with the successful blind decode result. In some aspects, to decode the PBCH based on the configured frequency offset, the UE can obtain the decoded symbols of the PBCH from the decoded information previously obtained during the successful blind decoding attempt of the one or more blind decoding attempts performed using the one or more different candidate frequency offsets, based on the decoded information of a successful blind decoding attempt being identified based on the inclusion of decoded symbols of the PBCH.

In some examples, the UE may detect the synchronization information (e.g., PSS and/or SSS) included in an SSB transmission centered on the raster frequency, and can attempt to decode the PBCH symbols (e.g., the PBCH RBs on the second, third, and fourth symbols of the SSB transmission) using each SSB pattern 610, 640, 670 of FIG. 6 and corresponding frequency offset as the hypothesis (e.g., a candidate frequency offset) for blind decoding. The UE can determine the configured frequency offset used for the SSB transmission based on a successful blind decode result. For example, if the UE successfully performs blind decoding of the PBCH symbols within the SSB transmission using the first SSB pattern 610 as the hypothesis (e.g., candidate frequency offset), the UE can determine that the configured frequency offset was zero. If the UE successfully performs blind decoding of the PBCH symbols within the SSB transmission using the second SSB pattern 640 as the hypothesis (e.g., candidate frequency offset), the UE can determine that the configured frequency offset was −4 RB. If the UE successfully performs blind decoding of the PBCH symbols within the SSB transmission using the third SSB pattern 670 as the hypothesis (e.g., candidate frequency offset), the UE can determine that the configured frequency offset was +4 RB.

In one illustrative example, the UE can be configured to open a larger bandwidth for search during acquisition mode, where the larger bandwidth opened by the UE is configured to cover the range of all possible RBs that could be included in any of the possible SSB patterns. For example, for an SSB bandwidth of 20 RBs and the possible SSB patterns corresponding to zero offset (e.g., SSB pattern 610 of FIG. 6), −4 RB offset (e.g., SSB pattern 640 of FIG. 6), and +4 RB offset (e.g., SSB pattern 670 of FIG. 6), the UE can open a larger bandwidth during SSB search and acquisition equal to 28 RBs (e.g., the 20 RB SSB bandwidth, plus 4 additional RBs above and below the SSB bandwidth corresponding to the +4 RB offset and −4 RB offset SSB patterns respectively). In some aspects, the larger bandwidth opened by the UE for SSB search during acquisition mode can be referred to as a “search bandwidth.” For example, the UE can determine a search bandwidth based on the configured SSB bandwidth (e.g., 20 RB) and one or more of the plurality of frequency offsets. For example, the search bandwidth can be equal to the configured SSB bandwidth plus the magnitude of the largest negative offset (e.g., −4 RB) plus the magnitude of the largest positive offset (e.g., +4 RB). The search bandwidth can be larger (e.g., wider) than the configured SSB bandwidth, based on one or more of the plurality of configured SSB patterns corresponding to a non-zero frequency offset between the PBCH and synchronization information (e.g., PSS and/or SSS) of the SSB.

In another illustrative example, the UE can perform the acquisition search using the configured SSB bandwidth. For example, the UE can perform the acquisition search using a search bandwidth of 20 RB with the synchronization information (e.g., PSS and/or SSS) of the SSB at the center of the search bandwidth (e.g., the search bandwidth and the synchronization information (e.g., PSS and/or SSS) are centered around the raster of the SSB). If the first SSB pattern 610 of FIG. 6 (e.g., with zero frequency offset) was used for the SSB transmission, the 20 RB search bandwidth includes the entire SSB transmission and decoding is performed normally. If the second SSB pattern 640 or the third SSB pattern 670 of FIG. 6 was used for the SSB transmission, a 20 RB search bandwidth can cause 4 out-of-band RBs to be punctured, which may correspond to a loss of approximately 1 dB for PBCH decoding.

In some aspects, the UE may perform a first PBCH decode using the first center frequency (e.g., raster, equal to the synchronization information (e.g., PSS and/or SSS) center frequency) as a center frequency of the PBCH, where the first PBCH decode is not based on the configured frequency offset or SSB pattern used for the SSB transmission. Based on a detected loss determined for the first PBCH decode, the UE can perform a second PBCH decode using the second center frequency (e.g., raster adjusted by the configured frequency offset) as the center frequency of the PBCH. For example, the UE may detect a loss associated with the first PBCH decode using the 20 RB bandwidth and/or associated with one or more out-of-band RBs being punctured causing 1 dB or greater loss for PBCH decoding. The UE can subsequently adjust the NB center frequency based on the determination of the SSB pattern and corresponding configured frequency offset between the PBCH and synchronization information (e.g., PSS and/or SSS) that was used for the SSB transmission. The determination of the SSB pattern can be based on the one or more explicitly signaled bits (e.g., included in the SSS of the SSB) and/or can be based on the blind decoding using each SSB pattern and corresponding offset as a hypothesis.

In some aspects, when the first PBCH RE mapping configurations 710, 740, 770 of FIG. 7 are used to map the PBCH bits to the SSB RBs in order of lowest to highest RB, the UE may be configured to perform blind decoding using each SSB pattern 610, 640, 670 as a respective hypothesis for the PBCH decode. In some aspects, the UE can use the PBCH DMRS to detect the three hypotheses. In some cases, for strong signal-to-noise ratio (SNR) conditions, the PBCH CRC can still pass, even if one or more out-of-band RBs are punctured (e.g., based on using a search bandwidth that is smaller than or does not include the full SSB pattern bandwidth, as noted above). In some aspects, if the SNR is low, the approximately 1 dB loss associated with the four out-of-band RBs being punctured during PBCH detection and decoding using the configured SSB bandwidth of 20 RBs as the search bandwidth may have a stronger relative effect on the detection and decoding performance, and the UE may be configured to adjust the NB center frequency based on the determined SSB pattern and corresponding configured frequency offset value, and then re-attempt PBCH decoding.

In examples where the second PBCH RE mapping configurations 810, 840, 870 of FIG. 8 are used to map the PBCH bits to the SSB RBs beginning from the lowest RE and RB within the synchronization information (e.g., PSS and/or SSS) bandwidth (e.g., 815, 845, 875, respectively), the UE can perform the PBCH decode starting from only one hypothesis of the SSB pattern and corresponding offset (e.g., using the 12 common RBs of the synchronization information (e.g., PSS and/or SSS) bandwidth 815, 845, 875 included in each SSB pattern, an approximately 2 dB loss may be associated with the PBCH decode). For higher SNR conditions, the 2 dB loss may be relatively minor and the decode can be successfully performed from the common PBCH bits of the synchronization information (e.g., PSS and/or SSS) bandwidth of each SSB pattern. For lower SNR conditions, the 2 dB loss may be relatively stronger in its effect, and the PBCH CRC may fail. Based on the PBCH CRC failing, the UE can then perform blind decoding attempts using each SSB pattern and corresponding configured frequency offset between the PBCH and the synchronization information (e.g., PSS and/or SSS) of the SSB as the hypotheses, and can subsequently adjust the NB center frequency based on determining the configured frequency offset based on a successful blind decode result.

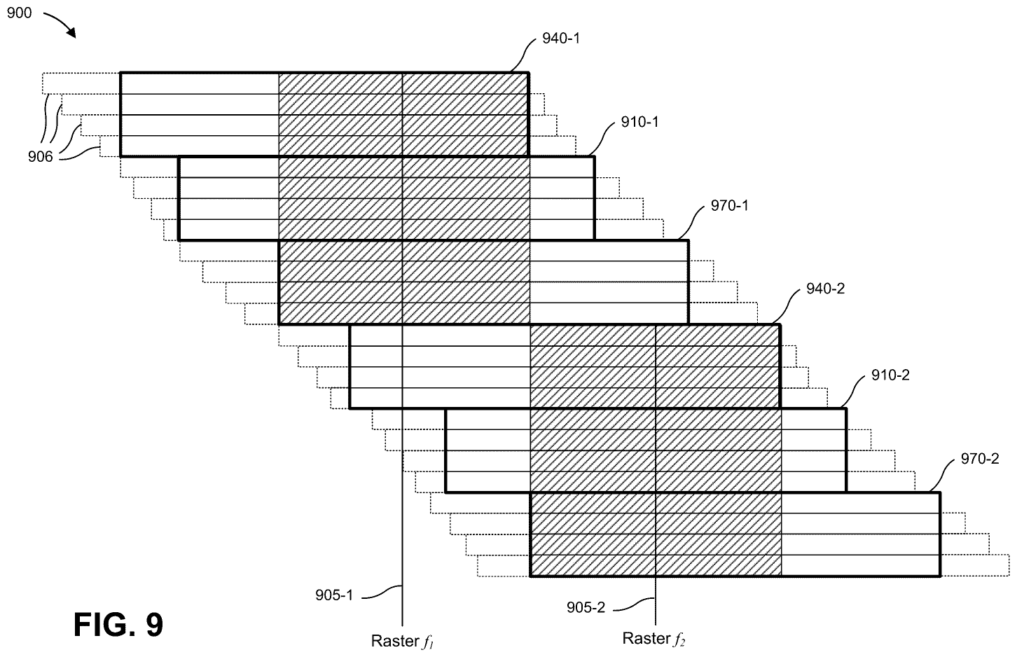

FIG. 9 is a diagram illustrating an example of Global Synchronization Channel Number (GSCN) raster locations 900 and the corresponding raster coverage for a plurality of downlink channels each offset by one resource block (RB), based on using the first, second, and third SSB patterns of FIG. 6, in accordance with some examples. For example, a plurality of DL channels 906 can be associated with the frequency range configured for SSB search and acquisition for a UE, where each respective DL channel of the plurality of DL channels 906 is offset by 1 RB from the adjacent (e.g., above and below) DL channels. Using only the first SSB pattern 610 of FIG. 6, with no frequency offset between the PBCH and the synchronization information (e.g., PSS and/or SSS) of the SSB, a total of 6 rasters would be needed to cover all of the 24 possible DL channels 906 where an SSB transmission may occur or be positioned by the network. For example, a first raster would be needed for the first four DL channels 906 (starting from the top of FIG. 9), a second raster would be needed for the next four DL channels 906, . . . , and a sixth raster would be needed for the last four DL channels 906.

In one illustrative example, SSB pattern switching between the plurality of configured SSB patterns and corresponding different configured frequency offsets (e.g., SSB patterns 610, 640, 670 of FIG. 6) can be used to reduce the number of rasters to cover the same quantity of DL channels 906. For example, using the SSB patterns 610, 640, 670 of FIG. 6, the 24 DL channels 906 of FIG. 9 can be covered for all possible SSB locations or positions using only two rasters, a first raster frequency f₁ 905-1 and a second raster frequency f₂ 905-2.

The first raster frequency f₁ 905-1 can be configured with the second SSB pattern 640 of FIG. 6 to cover the set 940-1 of four DL channels 906, based on the shaded portion of set 940-1 of DL channels representing the SSS of the SSB, the solid line white fill portion of set 940-1 representing the PBCH of the SSB, and the dashed line white fill portion of set 940-1 representing the RBs outside of the SSB bandwidth. For example, within the set 940-1 of DL channels, the PBCH is shifted (e.g., offset) to a lower frequency than the SSS centered about the first raster frequency f₁ 905-1, as in the second SSB pattern 640 of FIG. 6.

The first raster frequency f₁ 905-1 can be configured with the first SSB pattern 610 of FIG. 6 to cover the set 910-1 of the next four DL channels 906, based on the PBCH having the same center frequency (e.g., first raster frequency f₁ 905-1) as the SSS within the set 910-1 of DL channels.

The first raster frequency f₁ 905-1 can be configured with the third SSB pattern 670 of FIG. 6 to cover the set 970-1 of the next four DL channels 906, based on the PBCH being shifted (e.g., offset) to a higher frequency than the SSS centered about the first raster frequency f₁ 905-1 within the set 970-1 of DL channels, as in the third SSB pattern 670 of FIG. 6.

Using the three SSB patterns 610, 640, 670, 12 different DL channels of the respective DL channel sets 940-1, 910-1, 970-1 can be covered by the single first raster frequency f₁ 905-1.

Similarly, the second raster frequency f₂ 905-2 can be configured with the second SSB pattern 640 of FIG. 6 to cover the set 940-2 of DL channels, the same as or similar to the set of 940-1 of DL channels when using the first raster frequency f₁ 905-1. In another example, the second raster frequency f₂ 905-2 can be configured with the first SSB pattern 610 of FIG. 6 to cover the set 910-2 of DL channels, the same as or similar to the set of 910-1 of DL channels when using the first raster frequency f₁ 905-1. In another example, the second raster frequency f₂ 905-2 can be configured with the third SSB pattern 670 of FIG. 6 to cover the set 970-2 of DL channels, the same as or similar to the set of 970-1 of DL channels when using the first raster frequency f₁ 905-1.

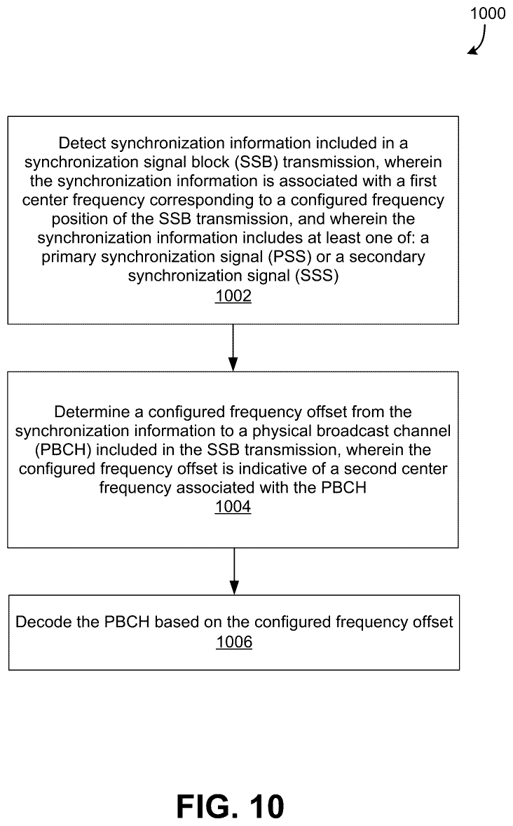

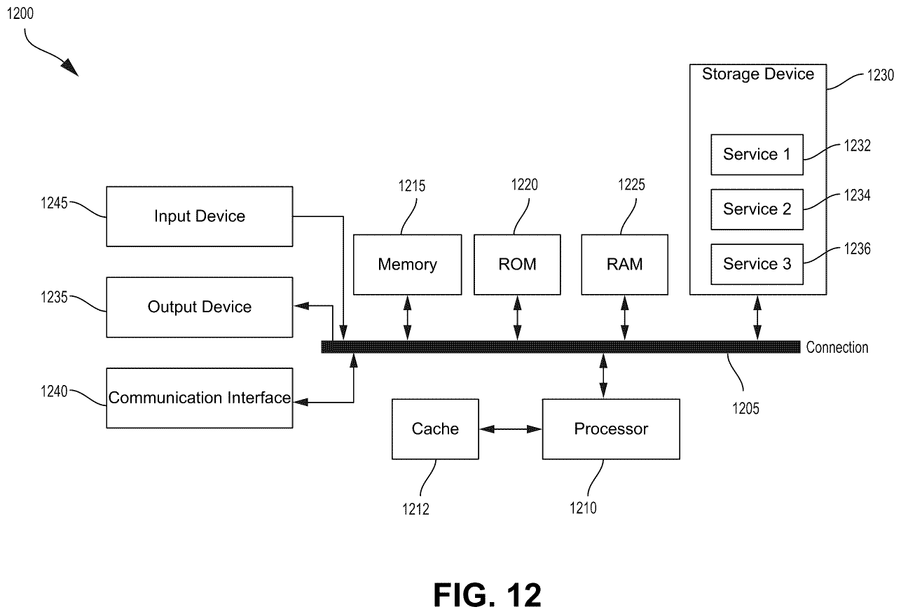

FIG. 10 is a flowchart diagram illustrating an example of a process 1000 for wireless communication. The process 1000 may be performed by a network entity or network device (or apparatus) or a component (e.g., a chipset, codec, etc.) of the network entity or device. The network entity may be a UE (e.g., the UE 104 of FIG. 1, FIG. 2, and/or FIG. 3, the wireless device 407 of FIG. 4, or other UE). The network entity (e.g., UE) can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 1000 may be implemented as software components that are executed and run on one or more processors (e.g., the transmit processor 264, the receive processor 258, the TX MIMO processor 266, the MIMO detector 256 of FIG. 2, the processor(s) 484 of FIG. 4, the processor 1210 of FIG. 12, or other processor(s)). Further, the transmission and reception of signals by the network entity in the process 1000 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 1240 of FIG. 12, or other antennae(s), transceiver(s), and/or component(s)).

At block 1002, the network entity (or component thereof) can detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS).

For example, the SSB transmission can be the same as or similar to one or more of the SSB transmissions 610, 640, and/or 670 of FIG. 6. The PSS can be the same as or similar to the PSS 612, 642, and/or 672 of FIG. 6, etc. In some cases, the SSS can be the same as or similar to the SSS 616, 646, and/or 680 of FIG. 6, etc.

In some examples, the synchronization information includes the PSS and the SSS. In some examples, the synchronization information includes the PSS. In some examples, the synchronization information includes the SSS.

In some cases, the configured frequency position associated with the SSB transmission is a particular frequency position included in a plurality of frequency positions of a synchronization raster. For example, the plurality of frequency positions can be the plurality of frequency positions 1-20 included in the synchronization raster of FIG. 5B. In some cases, the configured frequency position associated with the SSB transmission can be the same as or similar to one or more of the raster 605 of FIG. 6, the raster of FIG. 7, the raster of FIG. 8, the raster 905-1 or the raster 905-2 of FIG. 9, etc.

In some cases, the configured frequency position associated with the SSB transmission is a Global Synchronization Channel Number (GSCN) value.

At block 1004, the network entity (or component thereof) can determine a configured frequency offset from the synchronization information to a physical broadcast channel (PBCH) included in the SSB transmission, wherein the configured frequency offset is indicative of a second center frequency associated with the PBCH. In some examples, the second center frequency is different from the first center frequency.

For example, the PBCH can be the same as or similar to the PBCH 620, 650, and/or 680 of FIG. 6, etc. In some cases, the configured frequency position associated with the SSB transmission is a Global Synchronization Channel Number (GSCN) value, and the first center frequency associated with the synchronization information is determined based on the GSCN value. In some cases, the second center frequency associated with the PBCH is determined based on the first center frequency and the configured frequency offset. In some examples, the first center frequency can be the same as the raster center frequency 605 of FIG. 6.

In some examples, to determine the configured frequency offset, the network entity is configured to determine the configured frequency offset from a plurality of frequency offsets configured for SSB transmissions. In some cases, to determine the configured frequency offset, the network entity is configured to determine an SSB pattern associated with the SSB transmission, wherein the SSB pattern is indicative of the configured frequency offset. For example, the plurality of frequency offsets can include the frequency offset associated with the first SSB pattern 610 of FIG. 6, the frequency offset associated with the second SSB pattern 640 of FIG. 6, the frequency offset associated with the third SSB pattern 670 of FIG. 6, etc. In some examples, the SSB pattern is included in a configured plurality of SSB patterns, and each respective SSB pattern of the configured plurality of SSB patterns is associated with a respective frequency offset.

In some cases, to determine the configured frequency offset, the network entity is configured to determine the configured frequency offset from a plurality of frequency offsets. Each respective frequency offset of the plurality of frequency offsets can be indicative of a respective difference between the first center frequency and the second center frequency. For example, where the first center frequency is the same as the raster center frequency 605 of FIG. 6, each respective frequency offset can be indicative of a respective difference between the raster 605 and the second center frequency associated with the PSS and/or SSS of the synchronization information.

In some examples a first bit of the PBCH is mapped to a respective lowest frequency resource element (RE) of the SSB transmission, the respective lowest frequency RE based on the configured frequency offset and a bandwidth of the SSB transmission, such as in the various examples 710, 740, 770 of FIG. 7. In some cases, for each respective frequency offset of the plurality of frequency offsets, a first bit of the PBCH is mapped to a lowest frequency resource element (RE) included in a resource block (RB) associated with the synchronization information, such as in the various examples 810, 840, 870 of FIG. 8.

In some cases, the synchronization information includes the SSS, and to determine the configured frequency offset, the network entity is configured to decode the SSS to obtain first information indicative of the configured frequency offset. In some examples the first information is indicative of an SSB pattern included in a configured plurality of SSB patterns, where the SSB pattern corresponds to the configured frequency offset. In some cases, the first information is indicative of a quantity of resource blocks (RBs) or resource elements (REs) comprising the configured frequency offset.

In some examples, to determine the configured frequency offset, for each respective frequency offset of a plurality of frequency offsets, the network entity is configured to use the respective frequency offset to perform a blind decode of symbols of the SSB transmission associated with the PBCH. The network entity can determine the configured frequency offset based on a successful blind decode result.

In some cases, to determine the configured frequency offset, the network entity is configured to determine a candidate frequency offset from a plurality of frequency offsets configured for SSB transmissions, the plurality of frequency offsets including the configured frequency offset. The network entity can decode the PBCH based on the candidate frequency offset to determine decoded information for the candidate frequency offset. The network entity can determine, based on the decoded information including decoded symbols of the PBCH, the configured frequency offset is the candidate frequency offset.

In some cases, to decode the PBCH based on the configured frequency offset, the network entity is configured to obtain the decoded symbols of the PBCH from the decoded information for the candidate frequency offset. In some cases, the network entity is configured to determine the decoded information for the candidate frequency offset based on a demodulation reference signal (DMRS) included within the PBCH. In some examples, the network entity comprises a user equipment (UE), and the candidate frequency offset is associated with one or more of a cell search procedure or an acquisition mode of the UE.

In some cases, the network entity is further configured to determine a search bandwidth based on a configured SSB bandwidth and one or more of the plurality of frequency offsets, wherein the search bandwidth is larger than the configured SSB bandwidth. The network entity can decode the PBCH based on the candidate frequency offset and within the search bandwidth. In some cases, the network entity is configured to determine the search bandwidth based on the configured SSB bandwidth and a largest frequency offset of the plurality of frequency offsets.

At block 1006, the network entity (or component thereof) can decode the PBCH based on the configured frequency offset.

In some examples, a lowest frequency resource element (RE) associated with the PBCH is the same as a lowest frequency RE associated with the synchronization information. In some cases, to decode the PBCH based on the configured frequency offset, the network entity is configured to perform a first PBCH decode using the first center frequency as a center frequency of the PBCH, where the first PBCH decode is not based on the configured frequency offset. The network entity can perform, based on a detected loss determined for the first PBCH decode, a second PBCH decode using the second center frequency indicated by the configured frequency offset as the center frequency of the PBCH. In some examples, the network entity is further configured to perform a search over a plurality of frequency positions to detect the SSB transmission, the plurality of frequency positions including the configured frequency position, and receive, from a network entity, the SSB transmission using the configured frequency position.

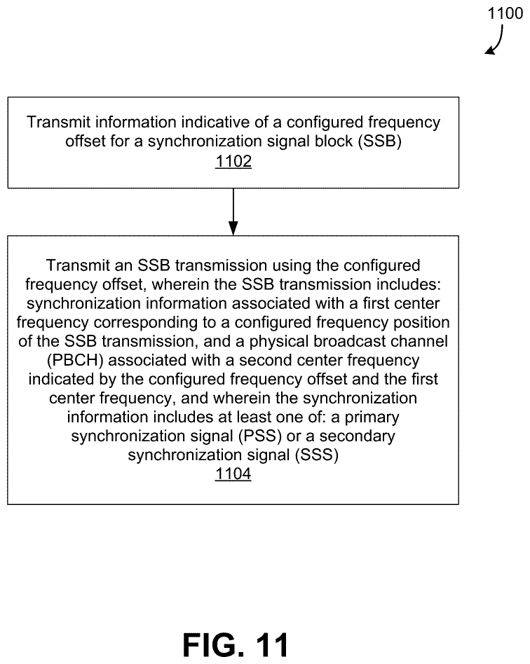

FIG. 11 is a flowchart diagram illustrating an example of a process 1100 for wireless communication. The process 1100 may be performed by a network entity or network device (or apparatus) or a component (e.g., a chipset, codec, etc.) of the network entity or device. The network entity may be a base station (e.g., an eNB, a gNB, etc.) or a portion of a base station (e.g., one or more of a CU, a DU, a RU, a Near-RT RIC, and/or a Non-RT RIC, such as the CU 310, the DU 330, the RU 340, the Near-RT RIC 325, and/or the Non-RT RIC 315 of the disaggregated base station 300 of FIG. 3), server device, or other network entity. The operations of the process 1100 may be implemented as software components that are executed and run on one or more processors (e.g., the transmit processor 220, the receive processor 238, the TX MIMO processor 230, the MIMO detector 236 of FIG. 2 and/or the processor 1210 of FIG. 12, or other processor(s)). Further, the transmission and reception of signals by the network entity in the process 1100 may be enabled, for example, by one or more antennas, one or more transceivers (e.g., wireless transceiver(s)), and/or other communication components (e.g., the transmit processor 220, the receive processor 238, the TX MIMO processor 230, the MIMO detector 236, the modulator(s)/demodulator(s) 232a through 232t, and/or the antenna(es) 234a through 234t of FIG. 2, the communication interface 1240 of FIG. 12, or other antennae(s), transceiver(s), and/or component(s)).

At block 1102, the network entity (or component thereof) can transmit information indicative of a configured frequency offset for a synchronization signal block (SSB). For example, the information can be the same as or similar to the synchronization information of block 1002 of the process 1000 of FIG. 10. In some cases, the configured frequency offset can be the same as or similar to the configured frequency offset of block 1004 of the process 1000 of FIG. 10. At block 1104, the network entity (or component thereof) can transmit an SSB transmission using the configured frequency offset, wherein the SSB transmission includes: synchronization information associated with a first center frequency corresponding to a configured frequency position of the SSB transmission, and a physical broadcast channel (PBCH) associated with a second center frequency indicated by the configured frequency offset and the first center frequency, and wherein the synchronization information includes at least one of: a primary synchronization signal (PSS) or a secondary synchronization signal (SSS)

In some cases, the computing device or apparatus configured to perform the process 1000 and/or the process 1100 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1000 and the process 1100 are illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1000, the process 1100, and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some aspects, computing system 1200 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1214 of high-speed memory connected directly with, in close proximity to, or integrated as part of processor 1210.

Processor 1210 may include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some aspects, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A network entity for wireless communication, comprising: at least one memory; and at least one processor coupled to the at least one memory, wherein the network entity is configured to: detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); determine a configured frequency offset from the synchronization information to a physical broadcast channel (PBCH) included in the SSB transmission, wherein the configured frequency offset is indicative of a second center frequency associated with the PBCH; and decode the PBCH based on the configured frequency offset.
Aspect 2. The network entity of Aspect 1, wherein the second center frequency is different from the first center frequency.
Aspect 3. The network entity of any of Aspects 1 to 2, wherein, to determine the configured frequency offset, the network entity is configured to determine the configured frequency offset from a plurality of frequency offsets configured for SSB transmissions.
Aspect 4. The network entity of any of Aspects 1 to 3, wherein, to determine the configured frequency offset, the network entity is configured to: determine an SSB pattern associated with the SSB transmission, wherein the SSB pattern is indicative of the configured frequency offset.
Aspect 5. The network entity of Aspect 4, wherein the SSB pattern is included in a configured plurality of SSB patterns, and wherein each respective SSB pattern of the configured plurality of SSB patterns is associated with a respective frequency offset.
Aspect 6. The network entity of any of Aspects 1 to 5, wherein, to determine the configured frequency offset, the network entity is configured to determine the configured frequency offset from a plurality of frequency offsets, and wherein each respective frequency offset of the plurality of frequency offsets is indicative of a respective difference between the first center frequency and the second center frequency.
Aspect 7. The network entity of Aspect 6, wherein a first bit of the PBCH is mapped to a respective lowest frequency resource element (RE) of the SSB transmission, the respective lowest frequency RE based on the configured frequency offset and a bandwidth of the SSB transmission.
Aspect 8. The network entity of any of Aspects 6 to 7, wherein, for each respective frequency offset of the plurality of frequency offsets, a first bit of the PBCH is mapped to a lowest frequency resource element (RE) included in a resource block (RB) associated with the synchronization information.
Aspect 9. The network entity of any of Aspects 1 to 8, wherein a lowest frequency resource element (RE) associated with the PBCH is the same as a lowest frequency RE associated with the synchronization information.
Aspect 10. The network entity of any of Aspects 1 to 9, wherein the synchronization information includes the SSS, and wherein, to determine the configured frequency offset, the network entity is configured to: decode the SSS to obtain first information indicative of the configured frequency offset.
Aspect 11. The network entity of Aspect 10, wherein the first information is indicative of an SSB pattern included in a configured plurality of SSB patterns, and wherein the SSB pattern corresponds to the configured frequency offset.
Aspect 12. The network entity of any of Aspects 10 to 11, wherein the first information is indicative of a quantity of resource blocks (RBs) or resource elements (REs) comprising the configured frequency offset.
Aspect 13. The network entity of any of Aspects 1 to 12, wherein, to determine the configured frequency offset, the network entity is configured to: for each respective frequency offset of a plurality of frequency offsets, use the respective frequency offset to perform a blind decode of symbols of the SSB transmission associated with the PBCH; and determine the configured frequency offset based on a successful blind decode result.
Aspect 14. The network entity of any of Aspects 1 to 13, wherein, to determine the configured frequency offset, the network entity is configured to: determine a candidate frequency offset from a plurality of frequency offsets configured for SSB transmissions, the plurality of frequency offsets including the configured frequency offset; decode the PBCH based on the candidate frequency offset to determine decoded information for the candidate frequency offset; and determine, based on the decoded information including decoded symbols of the PBCH, the configured frequency offset is the candidate frequency offset.
Aspect 15. The network entity of Aspect 14, wherein, to decode the PBCH based on the configured frequency offset, the network entity is configured to obtain the decoded symbols of the PBCH from the decoded information for the candidate frequency offset.
Aspect 16. The network entity of any of Aspects 14 to 15, wherein the network entity is configured to determine the decoded information for the candidate frequency offset based on a demodulation reference signal (DMRS) included within the PBCH.
Aspect 17. The network entity of any of Aspects 14 to 16, wherein: the network entity comprises a user equipment (UE); and the candidate frequency offset is associated with one or more of a cell search procedure or an acquisition mode of the UE.
Aspect 18. The network entity of any of Aspects 14 to 17, wherein the network entity is further configured to: determine a search bandwidth based on a configured SSB bandwidth and one or more of the plurality of frequency offsets, wherein the search bandwidth is larger than the configured SSB bandwidth; and decode the PBCH based on the candidate frequency offset and within the search bandwidth.
Aspect 19. The network entity of Aspect 18, wherein the network entity is configured to determine the search bandwidth based on: the configured SSB bandwidth and a largest frequency offset of the plurality of frequency offsets..
Aspect 20. The network entity of any of Aspects 1 to 19, wherein, to decode the PBCH based on the configured frequency offset, the network entity is configured to: perform a first PBCH decode using the first center frequency as a center frequency of the PBCH, wherein the first PBCH decode is not based on the configured frequency offset; and perform, based on a detected loss determined for the first PBCH decode, a second PBCH decode using the second center frequency indicated by the configured frequency offset as the center frequency of the PBCH.
Aspect 21. The network entity of any of Aspects 1 to 20, wherein the network entity is further configured to: perform a search over a plurality of frequency positions to detect the SSB transmission, the plurality of frequency positions including the configured frequency position; and receive, from a network entity, the SSB transmission using the configured frequency position.
Aspect 22. The network entity of any of Aspects 1 to 21, wherein the configured frequency position associated with the SSB transmission is a particular frequency position included in a plurality of frequency positions of a synchronization raster.
Aspect 23. The network entity of any of Aspects 1 to 22, wherein: the configured frequency position associated with the SSB transmission is a Global Synchronization Channel Number (GSCN) value; the first center frequency associated with the synchronization information is determined based on the GSCN value; and the second center frequency associated with the PBCH is determined based on the first center frequency and the configured frequency offset.
Aspect 24. The network entity of any of Aspects 1 to 23, wherein the synchronization information includes the PSS and the SSS.
Aspect 25. The network entity of any of Aspects 1 to 24, wherein the synchronization information includes the PSS.
Aspect 26. The network entity of any of Aspects 1 to 25, wherein the synchronization information includes the SSS.
Aspect 27. A method for wireless communication by a network entity, comprising: detecting synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); determining a configured frequency offset from the synchronization information to a physical broadcast channel (PBCH) included in the SSB transmission, wherein the configured frequency offset is indicative of a second center frequency associated with the PBCH, and wherein the second center frequency is different from the first center frequency; and decoding the PBCH based on the configured frequency offset.
Aspect 28. The method of Aspect 27, wherein the second center frequency is different from the first center frequency.
Aspect 29. The method of any of Aspects 27 to 28, wherein determining the configured frequency offset comprises determining the configured frequency offset from a plurality of frequency offsets configured for SSB transmissions.
Aspect 30. The method of any of Aspects 27 to 29, wherein determining the configured frequency offset comprises determining an SSB pattern associated with the SSB transmission, wherein the SSB pattern is indicative of the configured frequency offset.
Aspect 31. The method of Aspect 30, wherein the SSB pattern is included in a configured plurality of SSB patterns, and wherein each respective SSB pattern of the configured plurality of SSB patterns is associated with a respective frequency offset.
Aspect 32. The method of Aspect 31, wherein determining the configured frequency offset comprises determining the configured frequency offset from a plurality of frequency offsets, and wherein each respective frequency offset of the plurality of frequency offsets is indicative of a respective difference between the first center frequency and the second center frequency.
Aspect 33. The method of any of Aspects 31 to 32, wherein a first bit of the PBCH is mapped to a respective lowest frequency resource element (RE) of the SSB transmission, the respective lowest frequency RE based on the configured frequency offset and a bandwidth of the SSB transmission.
Aspect 34. The method of Aspect 32, wherein, for each respective frequency offset of the plurality of frequency offsets, a first bit of the PBCH is mapped to a lowest frequency resource element (RE) included in a resource block (RB) associated with the synchronization information.
Aspect 35. The method of any of Aspects 27 to 34, wherein a lowest frequency resource element (RE) associated with the PBCH is the same as a lowest frequency RE associated with the synchronization information.
Aspect 36. The method of any of Aspects 27 to 35, wherein the synchronization information includes the SSS, and wherein determining the configured frequency offset includes decoding the SSS to obtain first information indicative of the configured frequency offset.
Aspect 37. The method of Aspect 36, wherein the first information is indicative of an SSB pattern included in a configured plurality of SSB patterns, and wherein the SSB pattern corresponds to the configured frequency offset.
Aspect 38. The method of any of Aspects 36 to 37, wherein the first information is indicative of a quantity of resource blocks (RBs) or resource elements (REs) comprising the configured frequency offset.
Aspect 39. The method of any of Aspects 27 to 38, wherein determining the configured frequency offset comprises: for each respective frequency offset of a plurality of frequency offsets, using the respective frequency offset to perform a blind decode of symbols of the SSB transmission associated with the PBCH; and determining the configured frequency offset based on a successful blind decode result.
Aspect 40. The method of any of Aspects 27 to 39, wherein determining the configured frequency offset comprises: determining a candidate frequency offset from a plurality of frequency offsets configured for SSB transmissions, the plurality of frequency offsets including the configured frequency offset; decoding the PBCH based on the candidate frequency offset to determine decoded information for the candidate frequency offset; and determining, based on the decoded information including decoded symbols of the PBCH, the configured frequency offset is the candidate frequency offset.
Aspect 41. The method of Aspect 40, wherein decoding the PBCH based on the configured frequency offset includes obtaining the decoded symbols of the PBCH from the decoded information for the candidate frequency offset.
Aspect 42. The method of any of Aspects 40 to 41, further comprising determining the decoded information for the candidate frequency offset based on a demodulation reference signal (DMRS) included within the PBCH.
Aspect 43. The method of any of Aspects 40 to 42, wherein: the network entity comprises a user equipment (UE); and the candidate frequency offset is associated with one or more of a cell search procedure or an acquisition mode of the UE.
Aspect 44. The method of any of Aspects 40 to 43, further comprising: determining a search bandwidth based on a configured SSB bandwidth and one or more of the plurality of frequency offsets, wherein the search bandwidth is larger than the configured SSB bandwidth; and decoding the PBCH based on the candidate frequency offset and within the search bandwidth.
Aspect 45. The method of Aspect 44, further comprising determining the search bandwidth based on: the configured SSB bandwidth and a largest frequency offset of the plurality of frequency offsets.
Aspect 46. The method of any of Aspects 27 to 45, wherein decoding the PBCH based on the configured frequency offset comprises: performing a first PBCH decode using the first center frequency as a center frequency of the PBCH, wherein the first PBCH decode is not based on the configured frequency offset; and performing, based on a detected loss determined for the first PBCH decode, a second PBCH decode using the second center frequency indicated by the configured frequency offset as the center frequency of the PBCH.
Aspect 47. The method of any of Aspects 27 to 46, further comprising: performing a search over a plurality of frequency positions to detect the SSB transmission, the plurality of frequency positions including the configured frequency position; and receiving, from a network entity, the SSB transmission using the configured frequency position.
Aspect 48. The method of any of Aspects 27 to 47, wherein the configured frequency position associated with the SSB transmission is a particular frequency position included in a plurality of frequency positions of a synchronization raster.
Aspect 49. The method of any of Aspects 27 to 48, wherein: the configured frequency position associated with the SSB transmission is a Global Synchronization Channel Number (GSCN) value; the first center frequency associated with the synchronization information is determined based on the GSCN value; and the second center frequency associated with the PBCH is determined based on the first center frequency and the configured frequency offset.
Aspect 50. The method of any of Aspects 27 to 49, wherein the synchronization information includes the PSS and the SSS.
Aspect 51. The method of any of Aspects 27 to 50, wherein the synchronization information includes the PSS.
Aspect 52. The method of any of Aspects 27 to 51, wherein the synchronization information includes the SSS.
Aspect 53. A non-transitory computer-readable medium having code stored thereon that, when executed by an apparatus, causes the apparatus to: detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); determine a configured frequency offset from the synchronization information to a physical broadcast channel (PBCH) included in the SSB transmission, wherein the configured frequency offset is indicative of a second center frequency associated with the PBCH, and wherein the second center frequency is different from the first center frequency; and decode the PBCH based on the configured frequency offset.
Aspect 54. A non-transitory computer-readable medium having code stored thereon that, when executed by an apparatus, causes the apparatus to: detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS); determine a configured frequency offset from the synchronization information to a physical broadcast channel (PBCH) included in the SSB transmission, wherein the configured frequency offset is indicative of a second center frequency associated with the PBCH; and decode the PBCH based on the configured frequency offset.
Aspect 55. A method for wireless communication, comprising performing operations according to any of Aspects 1 to 26.
Aspect 56. A non-transitory computer-readable storage medium comprising instructions stored thereon which, when executed by at least one processor, causes the at least one processor to perform operations according to any of Aspects 1 to 26.
Aspect 57. A non-transitory computer-readable storage medium comprising instructions stored thereon which, when executed by at least one processor, causes the at least one processor to perform operations according to any of Aspects 27 to 52.
Aspect 58. An apparatus for wireless communication comprising one or more means for performing operations according to any of Aspects 1 to 26.
Aspect 59. An apparatus for wireless communication comprising one or more means for performing operations according to any of Aspects 27 to 52.
Aspect 60. An apparatus for wireless communication comprising one or more means for performing operations according to Aspect 53.

What is claimed is:

1. A network entity for wireless communication, comprising:
at least one memory; and
at least one processor coupled to the at least one memory, wherein the network entity is configured to:
detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS);
determine a configured frequency offset from the synchronization information to a physical broadcast channel (PBCH) included in the SSB transmission, wherein the configured frequency offset is indicative of a second center frequency associated with the PBCH; and
decode the PBCH based on the configured frequency offset.

2. The network entity of claim 1, wherein the second center frequency is different from the first center frequency.

3. The network entity of claim 1, wherein, to determine the configured frequency offset, the network entity is configured to determine the configured frequency offset from a plurality of frequency offsets configured for SSB transmissions.

4. The network entity of claim 1, wherein, to determine the configured frequency offset, the network entity is configured to:
determine an SSB pattern associated with the SSB transmission, wherein the SSB pattern is indicative of the configured frequency offset.

5. The network entity of claim 4, wherein the SSB pattern is included in a configured plurality of SSB patterns, and wherein each respective SSB pattern of the configured plurality of SSB patterns is associated with a respective frequency offset.

6. The network entity of claim 1, wherein, to determine the configured frequency offset, the network entity is configured to determine the configured frequency offset from a plurality of frequency offsets, and wherein each respective frequency offset of the plurality of frequency offsets is indicative of a respective difference between the first center frequency and the second center frequency.

7. The network entity of claim 6, wherein a first bit of the PBCH is mapped to a respective lowest frequency resource element (RE) of the SSB transmission, the respective lowest frequency RE based on the configured frequency offset and a bandwidth of the SSB transmission.

8. The network entity of claim 6, wherein, for each respective frequency offset of the plurality of frequency offsets, a first bit of the PBCH is mapped to a lowest frequency resource element (RE) included in a resource block (RB) associated with the synchronization information.

9. The network entity of claim 1, wherein a lowest frequency resource element (RE) associated with the PBCH is the same as a lowest frequency RE associated with the synchronization information.

10. The network entity of claim 1, wherein the synchronization information includes the SSS, and wherein, to determine the configured frequency offset, the network entity is configured to:
decode the SSS to obtain first information indicative of the configured frequency offset.

11. The network entity of claim 10, wherein the first information is indicative of an SSB pattern included in a configured plurality of SSB patterns, and wherein the SSB pattern corresponds to the configured frequency offset.

12. The network entity of claim 10, wherein the first information is indicative of a quantity of resource blocks (RBs) or resource elements (REs) comprising the configured frequency offset.

13. The network entity of claim 1, wherein, to determine the configured frequency offset, the network entity is configured to:
for each respective frequency offset of a plurality of frequency offsets, use the respective frequency offset to perform a blind decode of symbols of the SSB transmission associated with the PBCH; and
determine the configured frequency offset based on a successful blind decode result.

14. The network entity of claim 1, wherein, to determine the configured frequency offset, the network entity is configured to:
determine a candidate frequency offset from a plurality of frequency offsets configured for SSB transmissions, the plurality of frequency offsets including the configured frequency offset;
decode the PBCH based on the candidate frequency offset to determine decoded information for the candidate frequency offset; and
determine, based on the decoded information including decoded symbols of the PBCH, the configured frequency offset is the candidate frequency offset.

15. The network entity of claim 14, wherein, to decode the PBCH based on the configured frequency offset, the network entity is configured to obtain the decoded symbols of the PBCH from the decoded information for the candidate frequency offset.

16. The network entity of claim 14, wherein the network entity is configured to determine the decoded information for the candidate frequency offset based on a demodulation reference signal (DMRS) included within the PBCH.

17. The network entity of claim 14, wherein:
the network entity comprises a user equipment (UE); and
the candidate frequency offset is associated with one or more of a cell search procedure or an acquisition mode of the UE.

18. The network entity of claim 14, wherein the network entity is further configured to:
determine a search bandwidth based on a configured SSB bandwidth and one or more of the plurality of frequency offsets, wherein the search bandwidth is larger than the configured SSB bandwidth; and
decode the PBCH based on the candidate frequency offset and within the search bandwidth.

19. The network entity of claim 18, wherein the network entity is configured to determine the search bandwidth based on: the configured SSB bandwidth and a largest frequency offset of the plurality of frequency offsets.

20. The network entity of claim 1, wherein, to decode the PBCH based on the configured frequency offset, the network entity is configured to:
perform a first PBCH decode using the first center frequency as a center frequency of the PBCH, wherein the first PBCH decode is not based on the configured frequency offset; and
perform, based on a detected loss determined for the first PBCH decode, a second PBCH decode using the second center frequency indicated by the configured frequency offset as the center frequency of the PBCH.

21. The network entity of claim 1, wherein the network entity is further configured to:
perform a search over a plurality of frequency positions to detect the SSB transmission, the plurality of frequency positions including the configured frequency position; and
receive, from a network entity, the SSB transmission using the configured frequency position.

22. The network entity of claim 1, wherein the configured frequency position associated with the SSB transmission is a particular frequency position included in a plurality of frequency positions of a synchronization raster.

23. The network entity of claim 1, wherein:
the configured frequency position associated with the SSB transmission is a Global Synchronization Channel Number (GSCN) value;
the first center frequency associated with the synchronization information is determined based on the GSCN value; and
the second center frequency associated with the PBCH is determined based on the first center frequency and the configured frequency offset.

24. The network entity of claim 1, wherein the synchronization information includes the PSS and the SSS.

25. The network entity of claim 1, wherein the synchronization information includes the PSS.

26. The network entity of claim 1, wherein the synchronization information includes the SSS.

27. A method for wireless communication by a network entity, comprising:
detecting synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS);
determining a configured frequency offset from the synchronization information to a physical broadcast channel (PBCH) included in the SSB transmission, wherein the configured frequency offset is indicative of a second center frequency associated with the PBCH; and
decoding the PBCH based on the configured frequency offset.

28. A non-transitory computer-readable medium having code stored thereon that, when executed by an apparatus, causes the apparatus to:
detect synchronization information included in a synchronization signal block (SSB) transmission, wherein the synchronization information is associated with a first center frequency corresponding to a configured frequency position of the SSB transmission, and wherein the synchronization information includes at least one of: a primary synchronization signal (PSS) or a secondary synchronization signal (SSS);
determine a configured frequency offset from the synchronization information to a physical broadcast channel (PBCH) included in the SSB transmission, wherein the configured frequency offset is indicative of a second center frequency associated with the PBCH; and
decode the PBCH based on the configured frequency offset.
